(19) United States
(12) Patent Application Publication
(10) Pub. No.: US 2013/0144951 A1
(43) Pub. Date: Jun. 6, 2013

(54) Communication management system with extensible command language to consolidate and control multiple diverse communication mechanisms

(71) Applicants: Ravi N. Viswanath, Saratoga, CA (US); Suresh Sastry, Almaeda, CA (US); Frank W. Sudia, Wahington, DC (US); Mark Allen, Sunnyvale, CA (US)

(72) Inventors: Ravi N. Viswanath, Saratoga, CA (US); Suresh Sastry, Almaeda, CA (US); Frank W. Sudia, Wahington, DC (US); Mark Allen, Sunnyvale, CA (US)

(73) Assignee: Smeak, Inc., Saratoga, CA (US)

(21) Appl. No.: 13/680,008

(22) Filed: Nov. 16, 2012

Related U.S. Application Data
(63) Continuation-in-part of application No. 12/842,923, filed on Jul. 23, 2010, now abandoned.

(51) Int. Cl. H04L 29/08

(52) U.S. Cl. CPC H04L 29/08
USPC 709/204

(57) ABSTRACT

A computer-implemented communication management system allows its Users to consolidate a plurality of communication mechanisms and provides a single point of control to manage the reception, routing, processing, and retransmission of messages. The system includes an extensible command language that enables various user intentions, including complex routing, group creation, and group management, to be specified as single commands.

### 1. PRIORITY

This application is a continuation-in-part of U.S. patent application Ser. No. 12/842,923 filed Jul. 23, 2010, which was based on U.S. Provisional Patent Application No. 61/271,731 filed Jul. 23, 2009, both of which are hereby incorporated by reference in their entirety.

### 2. BACKGROUND

As electronic communication networks, such as the Internet, have continued to develop, a multitude of communication systems have been introduced, including email, chat, group chat, video chat, file sharing, bulletin boards, social networking, blogs, wikis, audio and video conferencing, and others. Each of these methods (or ‘paradigms’) has its structure, features, scope of applicability, formats, strengths, weaknesses, and methods of use.

These systems are rapidly converging, i.e., becoming more consistently integrated with each other and with telephonic and cell phone communication, SMS messaging, voice mail forwarding, e-commerce, payment systems, and the like.

Email's basic properties are well known. A local or web based client stores the user's mail account data, user IDs, passwords, address books, messages sent and received, and the like. Messages can be addressed to a group, and generally the user must select which mail account he or she wishes to send the message from. If the TO address is a message enabled cell phone, an email can be sent to a cell phone. If a telephone number has email-enabled voicemail, an email containing a digitally encoded file of the voicemail message can be sent to an email account.

Typical instant messaging (IM) systems include AOL Instant Messenger (AIM) and Yahoo Instant Messaging (YIM). Skype also has IM features. A user generally selects a single contact from an address book and initializes an IM session. This session may also provide a file transfer mechanism allowing one user to send a file to another, such as by dragging and dropping the file onto their chat session.

Twitter (www.twitter.com) provides a message-oriented communications method whereby large numbers of subscribers can ‘follow’ or be followed by other subscribers as they transmit short (140 character) personal comments and status updates, thus implementing a one-way group chat capability. Twitter allows messages to be sent from and received by cell phones in the form of SMS messages.

SMS (short message system) messages, highly popular among young persons, are typically sent to or received by cell phones. A computer server can also send and receive SMS messages through an SMS gateway. While SMS enabled systems provide address books, they do not provide groups or multiple aliases.

Email and IM have long been popular, and SMS usage continues to increase. For many (especially younger generation) users SMS has become a preferred method of communicating with peers, parents, and others, a preference they may be expected to carry forward into adulthood.

Thus there is a special need to provide more complete integration of SMS messaging with other forms of electronic communication, and to enable more sophisticated management of SMS and other communications among multiple parties, within the limitations of the features provided by inexpensive cell phones, and without any limitations on the types of sending and receiving messaging systems used, either now or in the future.

### 3. SUMMARY OF THE INVENTION

The present invention comprises an application server that can receive data messages through a plurality of gateways associated with different electronic communication mechanisms available today and in the future (see FIG. 1). Upon receipt of a message from a user, the CMS server will write the message to nonvolatile storage for backup and recovery, normalize the incoming data into a standard internal format, parse and activate any embedded commands, determine the desired mechanism(s) for retransmission of a given message, format the message for the selected retransmission mechanism(s), and retransmit the message to the designated or implied recipient(s) using the selected mechanism(s). An associated database contains the users' communication identities (System Addresses), address book(s), group definitions, routing preference rules, user-defined command language extensions, and other application, system and user data, including the information required to administer and manage the server computer. A Web interface allows users to update and manage their accounts (see FIG. 2), and allows administrators to configure and manage the system.

### 4. BRIEF DESCRIPTION OF THE DRAWINGS

FIG. 1 is a block diagram showing the components of the core application server, including gateways, and the flow of messages through the system.

FIG. 2 is a block diagram including the core application server plus other external system components including the Web application, Web services component, and remote command processor.

FIG. 3 shows a set of system Users who have pre-defined their delivery preferences, and their unification (by another User) into a Group with a default delivery preference.

FIG. 4 is a generalized system flow diagram showing how the system allows a User to create communication aliases for different external groups or audiences and then route the resulting communications to and from his or her personal communication accounts.

FIG. 5 is a generalized system flow diagram showing the primary operations to manage credits among and between the system and its users.

FIG. 6 is a generalized system flow diagram showing the primary operations to manage advertisements among and between the system and its users.

FIG. 7 is a flow diagram showing an example of the use of Smeak Lingo to encode and decode messages using a user definable dictionary.

FIG. 8 is a flow diagram showing an example of the paths taken by a message sent by a User to members of a Group who have selected varying delivery preferences.

### 5. DEFINITIONS & ABBREVIATIONS

As used in this provisional patent application the following terms and abbreviations will have the meanings specified below.

### 5.1. Definitions

Advertisement (Ad): A communication by a user of Smeak (see below for definition of Smeak) that advertises products or services of the user or an agency/firm represented by the user. The Ad is sent out by the user with certain properties and will be communicated by Smeak to users who have agreed to receive Ads that fulfill criteria that match those properties.

Alias: Any use of one User ID or User Name for another. Includes nicknames assigned to reduce typing and hostnames used in lieu of IP or physical network addresses, etc.

Blacklist: A listing of non-permitted senders, whose attempted communications will be disregarded.

CAPTCHA: Completely Automated Program to Tell Computers and Humans Apart. Generally implemented as a small visual or audio puzzle that should be easy for a human user to solve but difficult for an automated computer system.

Carrier: A provider of land based or cellular telephone service, including SMS service.

Cell Phone Number: A telephone number of a subscriber to a cellular telephone carrier.

Cellular Telephone (Cell Phone): A 2-way radio based communication method that provides Telephone Services (see below) to mobile users (subscribers) who subscribe to a given cellular telephone carrier.

Chat: Any of a number of session oriented communication methods that generally involve sending and receiving short textual messages in real time or near real time. A chat system can also support sending of one-time messages, for example to a user who is offline, without establishing a session.

Computer: A data processing system that may include one or more central processing units, random access memory system, one or more fixed disk data storage system, a power supply, one or more removable data media readers, one or more video display units, a keyboard, a pointing system (such as a mouse), one or more network adapter cards (which allow connection to other computers via Ethernet or optical networks), and other optional peripherals such as speakers, microphones, printers, scanners, and more.

Communication Management System (CMS): an internet oriented service that can allow its subscribers to coordinate a plurality of communication mechanisms and provides a single point of control to manage the reception, routing, processing, and retransmission of messages from and to multiple communication services.

Connection: See Friend.

Credit: A unit of barter within the system that can be purchased from Smeak (see below for definition of Smeak), earned from Smeak in return for performance of certain services such as referral of another user, purchased (or received as a gift) from another user of Smeak, or earned from another user of Smeak in exchange for performance of certain services such as viewing an Ad.

E-Commerce: Any of a wide range of methods for selling and/or purchasing goods and services, and effecting payment therefor, using a public network such as the Internet.

Electronic Mail (Email): an Internet oriented communication method that generally permits users to enroll in a system (hosted by their ISP), acquire unique user IDs and passwords, send/receive textual messages, which may have file attachments. Mail is typically accessed via the POP and SMTP or IMAP protocols. A specific instance of such a message plus any attachments.

Email Address: A globally unique identifier used for sending and receiving email consisting of at least a user name, followed by an ‘@’ sign, followed by a domain name, followed by a global top level domain. For example: bob@yourisp.com.

Friend: Another User, whether or not subscribing to the same communication system, who is a friend, correspondent, or acquaintance of the User, and whom the Primary User has pre-agreed to accept communications, sometimes also called a Buddy or Connection.

Group: A construct commonly used in computer-based applications for predefining that one or more User IDs, System Addresses, or other managed entities, will be associated into a named unit to allow permissions, restrictions, or other operations to be performed on all members of such Group by a single command, rather than having to repeat such commands for each Group member separately. Groups can overlap, that is, one Group can contain some but not all members of another Group.

Group Manager: A Smeak User or System Administrator who has the privilege to manage a Group, including creating the Group, and editing its profile information and policies, admitting or expelling members, managing any shares resources such as a bulletin board or wiki, and deleting the Group.

Identity: A higher-level abstraction of a System Address (see below) or group of System Addresses. This can take the form of a Friend Alias or Group Alias.

IM User ID: a user ID that is unique on a given IM service.

Instant Messaging (IM): an Internet oriented communication method that generally permits users to enroll in a (usually closed) system, acquire unique user IDs and passwords, look up friends or other contacts, send/receive and accept/deny connect requests, and initiate chat sessions, permitting the real time exchange of short textual, photo, or video messages, or data files. Examples include Yahoo Instant Messenger, AOL Instant Messenger, and Microsoft Communicator.

Internet Service Provider (ISP): a service organization having computers with direct network access to the Internet, which resells this access on a retail basis to a local user community.

Lingo: A user defined dictionary of abbreviations or code words and their definition. Smeak will translate incoming messages into the Smeak Users Lingo using the Users Lingo definitions defined in their dictionary. Outgoing messages will be translated from the Smeak Users Lingo into plain text.

Managed Public Group: A Public Group for which a Smeak User must request permission to join, such permission to be granted or denied by a Group Manager.

Managed User ID: A User account that is managed or overseen by a more highly privileged user, such as a parent or a corporate administrator.

Manager User ID: A more highly privileged user, such as a parent or a corporate administrator, that supervises and/or manages other subordinate User accounts.

Nickname: A short name assigned by a user as an alias for a longer name and/or System Address of him or herself or a friend, to reduce typing.

Open Public Group: A Public Group that any Smeak User may join.

Parental Controls: A system whereby a privileged user account of a parent can exercise control over a child's account.

Private Group: a Group created, defined, and managed by a User, and known only to the User, for his or her own convenience in organizing entities such as System Addresses and Friends and creating policies applicable to them.

Profile: In web based and social networking systems, general information about a User, which may include their name, user ID, system assigned account number, postal address, birth date, phone numbers, email addresses, website address, lists of Friends and their contact info, and other preferences. In an e-commerce application it can include order history, shopping preferences, payment card information, and the like.

Pseudonym: A non-genuine User Name, which can allow a User to communicate with some degree of anonymity, especially when using a public Internet based service. It can be apparent, such as ‘Sports Fan 99,’ or non-apparent, seeming to be an ordinary name. It can also be the assumed name of a User Agent, such as Smeak-Agent-JoeUser.

Public Group: a Group created, defined, and managed by the Smeak System, or by one or more Users, and known to all Smeak users. Public Groups can be either Open or Managed.

Short Message System (SMS): a popular method for sending and receiving short text messages from cellular telephones, and suitably equipped land based phones. Such messages can also originate at an email system.

Smeak: The system of the present invention, an Internet oriented communication method that allows its user/subscribers to consolidate a plurality of communication mechanisms and provides a single point of control to manage the reception, routing, processing, and retransmission of messages.

Smeak User ID: The user name and password of a unique user on the Smeak system.

Spam: Any form of unwanted or unsolicited communication; can include commercial messages or those from unknown or undesired communicators.

Subscriber: A user who has enrolled and is in good standing with a provider or carrier of a communications service, whether wireless, internet based, or land based.

System Address (sys_addr): A unique identifier of a subscriber to a communication system, used as the source or destination for messages. A system address thus comprises the system name plus the user's ID on that system. Examples include: YIM:JoeUser, Tel:4085551212, Email:Joe@User.com, etc. (A phone number type is an attribute of that phone number, not a system name.)

System Addresses can be further subdivided into:
(a) User System Address, the System Address of a given User (himself or herself) on each system he or she subscribes to,
(b) Smeak User System Address, one of the User's System Addresses on the Smeak system itself, that is, an address that will reach his or her Smeak User Agent.
(c) Friend System Address, the System Address of a given User's Friends on each system the Friends subscribe to, and
(d) User Agent System Address, the System Address or identifier assumed by an Agent acting on a User's behalf, with whom the User or the user's Friends will directly communicate. On a system (such as IM) which requires its users to pre-accept other communicators, the User and his or her Friends, may be required to pre-accept the User Agent System Address as one of their connections.

System Administrator: A highly privileged internal user employed by the Smeak system who generally has the power to allow or override any action of a Smeak User, but who preferably cannot impersonate any Smeak User or create messages in that User's name.

System Group: an internal Group created, defined, and managed by Smeak System administrators, and known to all Smeak Users or to all Users who are members of it. Examples may include the group of System Administrators, and of All Users, etc.

Telephone: A land line based communication method providing telephone service, generally including enrolling in a system, receiving a wire connection, a handset, and a unique telephone number, and initiating or receiving analog or digitally encoded real time voice communication sessions, and also originating and receiving voicemail messages.

Telephone Number: A globally unique identification number for use when accessing telephone services. Generally it has no password protection, and anyone with physical access to the handset equipment can make or receive a call. A password may be required to access voicemail and ancillary system services.

User: A person or automated agent that uses or accesses a computer, or subscribes to and initiates/receives messages or session based communications, whether wireless, Internet based, or land based. Generally synonymous with customer or subscriber.

User Agent: A program that manages a user's communication in accordance with predetermined preferences and preset instructions. For example, a user agent could be instructed to route communications from a specific source or class of sources to

User ID: A unique identifier, which may be an arbitrary combination of characters, that identifies a given user account on a given system or service.

User Name: The personal name of the User, which may nevertheless be a pseudonym.

Voice Over Internet Protocol: An Internet oriented communication method that supports a method of operation similar to telephone service, including enrolling in a system, receiving a unique user ID and password, and initiating digitally encoded real time voice communication sessions, and also originating and receiving voicemail messages, which may be processed as digitally encoded files.

Web Mail: A popular form of electronic mail that is hosted on an Internet web server, and hence can be accessed via any web browser. It may also offer POP and SMTP or IMAP access.

Web Server: a computer connected to a global network such as the Internet that can be accessed by users and upon request will return specially formatted web pages to a user that can be viewed via a web browser. Web pages are prepared in HTML format and are transmitted and received via the HTTP protocol. A web server may also include more complex programs that access a database, process transactions, etc.

Web Service (WS): An Internet oriented communication method that makes program features available to other computers via a remote procedure call method.

Whitelist: A mechanism to disregard all communications except those from pre arranged senders. A list used for such a purpose.

### 5.2. Selected Abbreviations

### AOL America Online, Inc.

### AIM AOL Instant Messenger

### CMS Communication Management System

### HTML Hyper Text Markup Language

### HTTP Hyper Text Transfer Protocol

### ISP Internet Service Provider

### SMK Smeak or the Smeak CMS

SMS Short Message System (for text messages on cell phones)

### SUA Smeak User Agent

### VOIP Voice Over Internet Protocol

### YIM Yahoo Instant Messenger

### 6. DETAILED DESCRIPTION OF THE INVENTION

### 6.1. General Operational Concepts

The Smeak CMS consolidates multiple communication mechanisms (e.g., SMS text messaging, email, instant messaging etc). For each communication mechanism and system the User has a User System Address that uniquely identifies them on a specific communication system or network. This may include an email address for SMTP email, a phone number for SMS text messages, or a user name for the various Instant Messaging systems they may subscribe to. The CMS uses User's routing preferences and other criteria to determine the actual delivery mechanism (User System Address) to use for each message.

The Smeak CMS provides its Users with a Web application that lets them enroll in the Smeak system, receive a unique Smeak User ID, and create a user account that contains (a) profile information including their personal User System Addresses that they wish to manage, (b) one or more address books containing Friend System Addresses and related information and attributes, and (c) zero or more Private Group definitions allowing the User to assign Friend's System Addresses (and his or her own) to various Groups for future processing in accordance with predetermined policies and preferences.

The Smeak CMS application server processes incoming messages addressed to the Smeak User ID, accesses the User's profile information, and follows routing rules to determine which delivery mechanism should be used for each message. These incoming messages can be (a) composed by the User and intended for delivery to one or more Friends (at one or more of their preferred User system Addresses), (b) composed by others, generally the User's Friends, and intended for delivery to the User (at one or more of his or her preferred User System Addresses), or (c) messages prepared by an automated agent process, generally the User's Smeak User Agent, and intended for delivery to either the User, his or her Friends, or both.

For example, a user named Fred may enroll in Smeak, select a Smeak User ID of fred79-smeak, and populate his Smeak account Profile with details of the communication mechanisms he wants to manage, by entering his User System Addresses, such as email addresses, phone numbers, and SMS user names. The Smeak CMS can now forward any messages sent to fred79-smeak to any of the User System Addresses Fred has specified, in accord with his stated preferences. Incoming email addressed to fred79-smeak@smeak.net, or incoming SMS or IM messages prefaced with the Smeak command ID=fred79-smeak will be routed to Fred via his then preferred delivery mechanism.

Privileged users can create subordinate ‘Managed User IDs’ that they can give to other Users but which can be monitored by respective ‘Manager User IDs’ and restricted in their usage. These ‘Managed User IDs’ and their ‘Manager User IDs’ form the basis for parental controls, and enterprise communications systems for companies that desire to implement content filtering, archiving, and other compliance rules.

The Smeak CMS has a command language and the Smeak application server will parse and process any commands contained within a message. Commands can alter the routing behavior to change the destination of that specific message, or can be used to change a user's profile information to modify the users preferred routing for all messages or messages fulfilling specific criteria.

For example user Fred may select one of his SMS phone numbers as his preferred delivery mechanism for all incoming messages. Messages for the fred79-smeak identity are routed to the specified SMS phone number. Later when Fred arrives at his computer, he can send a command in an email to fred79-smeak, which will be read and acted on by his Smeak User Agent, specifying his email address as his then preferred delivery mechanism.

The following sections describe in more detail the features, functions, and benefits of the Smeak Communication Management System (‘CMS’) of the present invention.

### 6.2. Identities

As used herein, depending on the context, the term Identity (plural Identities) can refer to:
a. A User System Address, i.e., the Name and./or User ID of a given person on a given external system, or in common parlance their ‘Identity’ on that system.
b. The totality of a given User's System Addresses on all systems subscribed to, equivalent to their Smeak profile, or whichever is/are active in accord with their then current preferences, sometimes called a Virtual Identity.
c. The Smeak Group ID of a Group that contains one or more User System Addresses, for either the User's Friends, of the User him- or herself.
d. The User's ‘Smeak User System Address.’
e. The ‘User Agent System Address’ of the User's Smeak agent.

### 6.3. Groups

The Smeak CMS allows users to organize their own messages, and interact with other Smeak Users. One of its primary features is the Group. A Group has a Smeak Group ID, and can be the source or destination for messages. It can contain Smeak User IDs and/or other Groups IDs so complex relationships can be represented. It also contains Group routing preferences. Messages sent to the Group ID routed to all Group members. Users can use the Web application to add or remove their identity from existing groups, or to create their own private Groups to organize the Smeak User IDs or external System Addresses of Friends they commonly communicate with.

The Smeak CMS combines the command language processing with the Group structures to implement:

6.3.1. Group Chat

A user can start a group chat session by including the group chat command in the initial message or by addressing it to a Group ID. The message is routed to the Smeak User IDs or Friend System Addresses listed in the group. The message will indicate in the From field or within the body, depending on mode of communication, that it is to the Group ID. Responses to these messages will also be to the Group ID, so all members of the group see all responses. The recipient will have an option to respond to the only sender (as a private out of band message), if desired. This mechanism implements group chat between users using different communication systems, via the Smeak CMS as an intermediary.

Smeak can accomplish the foregoing by either (a) requiring that all participating Users pre-accept the initiating User's SUA as a Friend on their preferred IM system, (b) having the initiating User's password(s) on the relevant IM systems and then logging in as (or impersonating) the initiating User on those systems, or (c) providing its own chat facilities so that all participants are merely logged into Smeak for the session. See Section 6.10 for more detailed Group Chat examples.

6.3.2. Knowledge Base Groups

For example, Users can create and join Knowledge Base Groups dedicated to answering questions from other Users. Any User can then send the Group a message with commands that specify a question for KB Group, including optional criteria such as time limits or geographic location. The Smeak CMS forwards the question to members of the selected (or a relevant) Knowledge Base Group, whose participating members then provide a response.

Example: A user can send a question to the Smeak Group ‘Restaurant-Gurus.’ The message contains the command:
Question=‘Italian Food

### Recommendations’::Location=‘Redwood City’

The application server forwards the question to members of the group, who can respond with an answer to the question. (See also Section 6.15.)

The entire Smeak community is also a group, identified by a reserved Group ID such as ‘All’. A user could thus (theoretically) send the same question mentioned above to the entire Smeak community. Similarly, groups or individuals can register their interest (or disinterest) in messages sent to the entire community that fulfill specific criteria. The Smeak CMS matches incoming messages sent to all users with the specific users and groups that would match appropriate criteria and qualifications of these messages, and then routes them appropriately to those users and groups.

### 6.4. How Smeak Interfaces with Multiple Systems

Smeak aims to provide its Users with flexible policy-based processing and routing of messages, especially short relatively textual messages. Through gateways, Smeak can access most popular communication systems. However, communication systems vary in the types of messages they accept and the means and costs required to access them.

When accessing a communications network or system, either to receive messages from a subscribing Smeak User, or to send or relay messages on behalf of one, Smeak must access that system, either as Itself (using a general purpose ID of its own) or using a custom sub-ID (of its own) for the subscribing user. (In selected cases, depending on policy, Smeak could possibly impersonate the user, using his or her exact credentials, so messages originating from Smeak would seem to come directly from that User.)

When Smeak receives a message addressed TO a given Smeak User, at one of his Smeak User System Addresses, Smeak must determine whether the message is intended to be read and acted on by that User's Smeak User Agent (SUA), or forwarded onward to the User at one of his or her preferred Other System User Addresses.

When Smeak receives a message FROM a given Smeak User, which will generally contain a command to the SUA from the User, Smeak must determine whether the message is authenticated. Such a message could be either (a) a command to his or her SUA to alter one or more of the User's profile settings, or (b) an instruction to route a given message to one or more named or implied recipients or groups.

| Feature | Email | IM | SMS |
|---|---|---|---|
| Whitelisting or ‘connection’ | N | Y | N |
| required | | | |
| Cost to send or receive | N | N | Y |
| SUA could impersonate User | Y | Y | ? |
| Sub-User accounts feasible | Y | N | N |
| Considered authenticated if | Y* | Y | Y |
| from User | | | |

*with Message Identification and Authentication as described in Para. 6.22

### 6.5. Virtualization of Multiple Communication Identities

The system of the present invention allows end users to consolidate their User IDs for multiple communication mechanisms into one or more Virtual Identities (of themselves). This can allow messages addressed to a given virtual identity to be routed to any one of the mechanism specific identities referenced by the virtual identity. Virtual identities can reference one, several or all of the mechanism specific identities of the end user. The end users can create multiple virtual identities.

An example of this system would be the end User John Doe who has the following mechanism specific User IDs or System Addresses:
john.doe@work.com (work email)
jdoe@yahoo.com (personal email 1)
johndoe@gmail.com (personal email 2)
john-doe (IM identity)
4085551234 (Work Phone number for SMS text messages)
4085556789 (Home Phone number for SMS text messages)
thedoester (Twitter Identity)

The system allows John Doe to create the following virtual users:
jd.work references the mechanism specific identities john.doe@work and the work phone number 4085551234)
jd.home references the mechanism specific identities jdoe@yahoo.com, johndoe@gmail.com, john-doe, and the home phone of 4085556789.
jd.emerg references all of John Doe's communication identities, for possible use to contact him in case of an emergency.

Messages to jd.work would only have john.doe@work and the work phone number 40855512324 as destination candidates. Messages to jd.home would only have jdoe@yahoo.com, john-doe, and the home phone number of 4085556789 as destination candidates. Messages to jd.emerg would have all available mechanisms as destination candidates, except his outbound Twitter identity.

John gives his personal contacts his personal ID which is jd.home@smeak.net. He can choose to route messages sent to this personal ID to any of the communication mechanisms he has defined under jd.home and can use multiple criteria to determine which of these mechanisms receives the message. Smeak CMS is also capable of determining John's Smeak Identity from the individual communication mechanism—thus an SMS to 4085556789@smeak.net will also reach John's personal account. Anyone, including non-members of Smeak, can send messages to John from any system or mechanism (e.g. email, SMS). Whether and how the messages reach him are dependent on how John's preferences. In this manner, Smeak CMS has helped John virtualize his personal emails, mobile phone number, and his IM ID into a single identity. Smeak CMS provides a mechanism for John to define rules that will automate the delivery of specific messages to the specific communication mechanism.

Similarly, John can ensure that communications to specific recipients or groups are sent via specific communication channels.

### 6.6. Identity Grouping

The system of the present invention allows creation of multiple and possibly hierarchical Group IDs to establish and manage relationships between communication identities. Identity Groups have their own identity and can be destinations for messages. The Identity Group references specified individual identities, virtual identities or other Group Identities. Identity Groups contain a preferred communication mechanism for the group. Messages to an Identity Group are routed to the members of the group, but are limited to the mechanisms specified for the Identity Group.

For example, an Identity Group may be established which limits messages to email only. Messages to the Identity Group will be limited to email as the communication mechanism. When more than one mechanism is specified for the group, the choice of delivery mechanism will depend of the individual preferences defined for the individual members of the group.

### 6.7. Extensible Identity Properties

Each Identity in the system has a set of properties that contain information related to the identity. Standard items include the users profile information (i.e. Name address etc.) the users real communication information (i.e. email addresses, SMS phone numbers etc.) and users geographic location information (i.e. ‘Home’, ‘Work’, ‘New York, N.Y.’ etc.) Properties are associated with Individual Identities, Virtual Identities and Group Identities. Individual Identities inherit the properties of any Virtual or Group Identities they belong to.

New properties can be added to the identity at any time extending the available properties for the particular Identity or members in the Identity Group.

Properties are visible to other identities based on the protection setting of the property. The following settings are used:
1. Private: Property values can only be used by the owning identity.
2. Public: Property can be used by all identities.
3. Restricted: Property can only be used by a restricted set of identities.

### 6.8. Structured Preference Mechanisms

The system allows users to specify properties and delivery preferences for each identity, Virtual Identity and Group Identity. Because Virtual Identities and Group Identities behave as ‘containers’ for other identities, the case will exist where the identity and its container identity both specify the same property or delivery preference. In this case, the property or delivery preference specified by the containing identity takes precedence over what is specified at the Identity level. The system implements a method to override this behavior by allowing users to specify at the container level the property or delivery mechanism to be used for this identity when in the context of the container (i.e. Group or Virtual Identity).

For example, a preference pertaining to a group can be overridden by one pertaining to an individual. User Joe may wish to see all messages coming to a group he is interested in called ‘Gardening’ but may wish those messages to go to an email account for later viewing. However if a message to the same group is from a sender called Jane, Joe may wish to see that message sent as a text communication. Thus the preference related to an individual overrides the group preference. Similarly, Joe may wish all messages to go to his email account, except for those sent by his family. In this case a group overrides a global preference.

### 6.9. Preservation of Anonymity

The system allows users to create and delete virtual identities that can be used to protect their identities and avoid becoming the target of spam. Users can expose the virtual identity when messaging, perhaps accessing a high risk forum, and then delete the virtual identity without affecting the primary identity.

Example: The user John Doe has a Smeak Identity jdoe.personal. He creates and adds virtual identities jdude, jdog, jdoe_ads. He can use these virtual identities just like he uses his regular Smeak Identity. He can selectively associate different virtual identities with different groups. If he deletes identity jdude, he can do so without deleting his account. This is a big convenience in circumstances where he feels the identity is compromised.

### 6.10. Virtual Group Messaging

Group discussion sessions require routing a response to a message from one member in the discussion group to all members in the group. This functionality is not inherent in all communications mechanisms in use. The system provides virtual group messaging by implementing this functionality across all mechanisms through the use of Identity Groups and the Command Language. With virtual group messaging, participants are part of an Identity Group. Embedded commands in the messages or in the ‘From’ address, depending on means of communication, indicate the message is part of a group discussion. The system then uses the commands to route responses to messages back to all members of the Identity Group. This mechanism would be used for multiple applications from social chatting to corporate communications.

Example: User Joe sends message to a private group (i.e., defined by user Joe) called Gardening. Some messages are communicated via email, to SMS devices as well as regular email addresses. Others are communicated directly via SMS. The messages communicated via email pertain to come from an email ID at Smeak CMS that could contain both the sender ID and group indicator, along with a unique identifier, like Joe_Gardening_{—}12345678@smeak.net. Smeak CMS will in this case maintain information associated with this From ID, of the list of recipients of the message. A response to this email ID will then allow Smeak CMS to reference the list of original recipients so that the response can be sent to them. In a circumstance where SMS is not sent across email from Smeak CMS, the body of the message will contain the group identifier Gardening, and the responder will need to similarly reference it using a command, in order to respond to the group.

The following examples illustrate the message flow through Smeak:
1. John Doe, a member of Smeak CMS, sends a message by email to his private group, Group1.
   a. The message is sent to Group1@smeak.net.
   b. Smeak CMS identifies that the message comes from member John Doe and looks within his address book to parse the TO address, ‘Group1’.
   c. Group1 is found to be defined within John Doe's environment. The members of Group1 are found to be Joe, Mark, and Tom.
   d. Joe is a member of Smeak CMS. His preferences are to receive messages via email.
   e. Mark is a member of Smeak CMS. His preferences are to receive messages via SMS.
   f. Tom is not a member of Smeak CMS. John Doe has defined him as a contact with his SMS number defined.
   g. Smeak CMS sends email to Joe. The message purports to come from an ID which includes the sender, the group and a unique identifier, e.g. JohnDoe_Group1_{—}123456@smeak.net. This message identification is stored by Smeak CMS along with the list of recipients.
   h. Joe receives the email and replies to it. The reply goes back to JohnDoe_Group1_{—}123456 and Smeak CMS constructs the list of original recipients from this identification, and communicates the response to the group. If Joe has a preference set to not respond to the entire group, then Smeak CMS will just send the reply only to John Doe.
   i. Mark receives an SMS message on his mobile device, which comes from Smeak's phone number. Within the body of the message is an identification set with the sender and the group in it, to with John Doe and Group 1.
   j. Mark replies to this SMS. He indicates in the body of the message via Smeak commands (see 6.12) that it should go to Group1 by including the message identification.
   k. Smeak CMS identifies the message as a reply to John Doe and includes John Doe's Group1 in the recipient list.
   l. Tom receives the message just as Mark does and can respond similarly.
2. John Doe, a member of Smeak, sends a message via email to a group, Gardening.
   a. The message is sent to Gardening@smeak.net.
   b. Smeak CMS identifies that the message comes from member John Doe and looks within his address book to parse the TO address, ‘Gardening’.
   c. The group ‘Gardening’ is not found to be defined within John Doe's environment. Smeak CMS then looks at public groups and finds the group ‘Gardening’.
   d. Smeak CMS looks at the properties of group ‘Gardening’ and finds that the group restricts messages to members of the group only.
   e. Smeak CMS finds that John Doe is indeed a member of the group Gardening. It then retrieves the members of the group and proceeds as in the prior example.

### 6.11. Recipient-Controlled Message Behavior

With communication using a single delivery mechanism, the mechanism being used determines message routing. This system takes advantage of the multiple delivery mechanisms supported to give end users control over the routing behavior. Using preferences established at the Identity, Virtual Identity or Identity Group level, end users can control:
When or if the message is received
What form it is received (e.g. text, HTML, summary, subject only, every N messages only etc.)
Preferred delivery mechanism
If the message should be archived

These preferences would be activated based on multiple factors, including:
The sender's identity
Embedded commands in the message (example: whether a question is being asked and the recipient has registered preferences to answer questions with the relevant other criteria, if any)
The location of the sender and/or the recipient
Descriptive qualities such as keywords annotating the message

Example:
See messages addressed to ALL members where the keyword is ‘gardening’, and route such messages to my email joe@yahoo.com
See messages addressed to ALL members where the keyword is ‘food’ or ‘restaurant’ and location is ‘northern California’ and send such messages over SMS to my phone
See messages addressed to group ‘gardening’ and route those to my email johndoe@gmail.com
If user ‘janedoe’ sends me any message, send it to my phone over SMS
   Now if janedoe sends a message to group ‘gardening’, the preference associated with janedoe will override the preference associated with ‘gardening’ and johndoe will get an SMS.

### 6.12. Intelligent Command Interpreter

The system includes a command interpreter to process commands embedded in messages. The command language syntax allows messages to contain special handling information directing the routing and processing of the message. Messages may also be command only with no message to deliver. The interpreter contains the intelligence to remember an end user's previous uses of commands and parameters, allowing previously used values to become the default value for the command. Subsequent uses of the command can omit the repeated data, minimizing the number of keystrokes needed when a series of commands are used. The Intelligent Command Interpreter can be used to implement the following features:

Implementation of a ‘virtual agent’ which manages a user's communication much in the manner of an electronic secretary. The virtual agent has multiple attributes including:

Execute actions on behalf of the user: The agent can be instructed to execute actions on behalf of the user, upon request, at pre-programmed times, or as a consequence of other actions. For example, the agent can be instructed to send a file to a list of users, or to download a document. The number of such different tasks can be extended ad infinitum, for example as described in Sections 6.8 and 6.15.

Ultimately we visualize and define a system where an individual can instruct a computer agent to perform tasks on their behalf from wherever they are. We start with basic communication tasks and will extend them from there.

‘Sticky communication.’ The command interpreter remembers recent attributes of communication implicitly and/or explicitly. Example of these attributes would include location information, last list of addressees, etc. Subsequent communications where these values are not overwritten can use the last values.

The user could thus send a communiquè to Joe, Mark and Tom.

The next communiquè may have no addressees, but if there is a message in the communiquè it would go to Joe, Mark and Tom unless the user's preferences instruct the agent not to remember last values.

### 6.13. Structured, Extensible, User-Definable Command Language

The command syntax used by the command processor is an extensible language that allows individual and group identities to extend the basic command structure by adding their own new or enhanced commands. These language extensions will be available only for the individual or group that created the extensions. They can however be exported or made available by the creator to other users who can import them.

The language syntax has the following characteristics:
1. This mechanism allows for structure in otherwise unstructured communication within the body of messages such as those in text messages and email messages.
2. The mechanism divides the body of the message into a command section and a payload section separated by separators. These separators have default values that can be changed (personalized) by the sending user.
3. The payload section is the message that is to be communicated. Both command and payload sections are optional.
4. The command section is divided into command phrases, each separated by a separator which also has a default value and can be changed (personalized) by the sending user
5. Each command phrase is divided into commands and parameters, separated by separators which have a default value and can be changed (personalized) by the sending user
6. Each command has a default value and can be changed (personalized) by the sending user
7. The parameters of a command depend on the command. The parameter can either be a value or referenced value. A referenced value is an index pointing to a saved location on the uses profile. For example, a command can be of the form
   Setlocation:Joe's House
   In the above, ‘Joe's House’ is a description that is saved. Alternatively, it could be
   Setlocation:2
   In iii, the user has saved ‘Joe's House’ in location 2 previously at the agent
   Both the above set the user's location to be Joe's House. This could be retrieved by another authorized user, or otherwise used appropriately
8. Phrases of the command language can be sent together with a payload or separately. As described in [elsewhere] the system can remember prior phrases so that the effect is the same as sending them together.
   Examples: the message body is ‘Setlocation:Joe's House|I am at Joe's house’
   In above, command phrase ‘Setlocation:Joe's House’ is the command and ‘I am at Joe's house’ is the payload
   The same effect could be achieved by two different messages
   The first message would be ‘Setlocation:Joe's House’ and the second (or later one if Setlocation is not invoked again with a different value) would be ‘I am at Joe's House’

### 6.14. Message Routing Control Using Command Language

End users may alter the routing behavior of their messages using commands available in the command language provided by the system. Since the command language is available in all communication methods, this control becomes available to the end user through the use of any of their remote communication devices. Since the command language is extensible, simple commands can be created to specify a set or routing changes to the message. This capability creates a wide array of possible functions to the end user. Examples are:
1. Temporarily halting delivery—the electronic equivalent of holding one's calls, in this case text, email and other interruptions, until restarted or for specific periods of time
2. Message filtering it based on priority, sender and other criteria, so as to provide the effect of, for example ‘don't interrupt me during this meeting unless it is my wife or client XX trying to get in touch’

### 6.15. User-Defined Message Decoding and Encoding

The system gives Smeak Members the ability to define their own language dictionary that contains the Members personal code words for the words and phrases they use in their messages. Members may then use their personal language, or ‘Lingo’ when creating messages and reading received messages. The Smeak system will encode all incoming messages into the Members defined ‘Lingo’ by locating in the message any instance of a word or phrase that has been defined in the Members dictionary with the corresponding code word. Outgoing messages will be decoded by replacing in the outgoing message any instance of a defined code word with the word or phrase it represents.

### 6.16. Human Knowledge Base

The system provides a set of Identity Groups (see also Section 6.3.2) that are available to all end users of the system. End users wishing to share their knowledge may add their identities to these groups to become part of a living human knowledge base. As described earlier, the universe of Smeak CMS users, referenced by the reserved Group Identity ‘All’ is also a Group. Using the command language, the end user can specify their area of expertise, geographic location etc. Members that need access to the knowledge base can send a message, posing a question to the group. The system will rout the question to members of the group that have indicated they have expertise on the subject. The system allows commercial providers of goods and services to participate in the knowledge base. Responses from commercial providers will be identified just as ‘sponsored links’ are identified in today's WEB search engines. Questions posed to the knowledge base can be time limited, when responses after a set period of time are no longer relevant. End users can request individual responses or a single statistical response indicating how the knowledge base responded as a group. Limits can be placed on the number of individual responses a requester is willing to accept.

This feature can be used to implement many applications with significant commercial and social value. For example:
1. Provides a means for commercial providers of goods and to respond with targeted advertising in real-time to a wide array of communication mechanisms. Advertisements can be in the form of live providers responding to the message or Pre-set Advertisements automatically sent to the provider.
2. End users can request a service, and responses can be limited to those providers that can provide the service in the time span and geographic area requested. The request ‘I need a plumber now’ only receives responses from plumbers in the area that are available now. The service requester could further annotate the message, or set prior preferences, to specify whether they will pay for this service and a maximum amount.
3. End Users can request a statistical response for questions regarding potential purchases (‘Which is better Sony or Samsung?’)
4. Real time polling of the Knowledgebase on social issues such as ‘who will you be voting for?’ or ‘How is the President doing?’
5. Commerce applications can be based on the ability to match requestors needing goods or services with a provider of those goods and services.

### 6.17. Recipient Control of Knowledge Base Responses

Through the use of the command language and its extensions, the system gives requestors control over the type and number of responses they want to receive. The system gives the following control over responses:
Accept or reject responses from commercial ‘sponsored’ responders.
Allows requestors to control and filter out commercial responders, or with the addition of other filtering criteria limit the types of commercial responses that are allowed. This would provide the capability for restrictions to seeing ads only where there are rewards or credits for doing so.
Accept or reject responses from individual responders.
Used when only responses from commercial responders are desired.
Accept or reject responses outside of the geographic location.
Used when responses outside the geographic area will not be relevant. For example, a request for ‘a good restaurant in St. Louis, Mo.’ would be best answered by responders in the St. Louis, Mo. area.
Accept or reject responses after the request expiration time.
Recipients only receive responses during the time the request is active. Responses beyond the expiration time are not relevant. Examples would be:
   ‘I need a plumber now’ may have a short time to expire. Responses coming next week are no longer relevant, so would not be delivered.
   For commercial responses, it can restrict the receiving of advertisements only up to a certain time period (I am in the market for a TV; but once I have bought it, I don't want further ads on)
Request individual responses or single statistical response.
Anonymous requests
This would allow consumers to retain anonymity when making a request, protecting the consumer against future advertising and spam by means of a virtual identity and identity aliasing.

### 6.18. Managed User IDs

The system implements a set of administrative controls allowing a privileged user to create Managed User IDs on the system. Managed User IDs are identical to individual Smeak User IDs except they are subject to the controls applied by the privileged users who are their respective Manager User IDs. The relationship is:
A Managed User ID can have several Manager Identities. Example: the CIO as well as the IT admin can potentially have control over an employee's Identity; Either of a mother or father can have control over their child's account.
A Manager Identity can control several Managed User ID.

Such privileged users with Manager User ID have the ability to:
Create, delete, suspend or reactivate the Managed User ID.
Convert existing identities into Managed User ID (this will require consent at both sides). Example: Teenager Joe creates an account. Later on his mother creates a Manager User ID, and asks Joe to accept to convert his existing Smeak User ID into a Managed User ID.
Modify the attributes of the Managed User IDs.
Limit the ability of the Managed User ID to modify attributes.
Limit the communication mechanisms used by the Managed User ID.
Limit the volume of messages.
Enable archiving of all messages going to and from the Managed User ID.
Monitoring of message content through manual scanning and automatic scanning.
Control usage of Virtual Identity and Group participation.
Create Command Language extensions usable for all Managed User IDs.
Generate reports on Managed User ID usage.

This capability is used to implement parental controls and corporate communication networks. For parental controls the implementation will:
1. Allow parents to control messaging costs (for text messaging), supervise documents/images exchanged, as well as discreetly monitor their wards/children
2. A parent, as a privileged user, creates managed identities for their children/wards and ensures that the minors use their Managed User IDs only for text messaging.
3. The text messaging costs can be high. By placing controls on number of text messages, as well as addresses that the child/ward can use to communicate, the parent can control these costs.
4. Recently concerns have arisen regarding Video/Pictures transmitted by minors from cell phones. Managed User IDs can allow parents to control/monitor the pictures/videos being transmitted by the children/wards.

For corporate communication systems the capability will be used to implement
1. Administrative accounts and user accounts.
2. Audit logging of communications.
3. Policy adherence (e.g. communications with customers only through corporate addresses, ensuring common signature lines, always copying certain accounts, structured grouping to ensure that backups are notified if primary is on vacation, return receipt, priority notifications)
4. Structured reporting
5. Alerts
6. Corporate monitoring

### 6.19. Identity Linking

The system provides users a mechanism to link multiple identities allowing the identities to share properties. This mechanism allows users that have been given access to one or more managed identities to control messaging from a single identity. Messages can then be sent from one identity using the properties of the identity it has been linked to. Properties the system allows to be linked are:
Profile information including user's location and communication preferences
Routing Rules
Command Extensions
Virtual identities and Group identities
Extended properties

Linking can be one-way such that Identity-A can link to and use the properties of Identity-B, but Identity-B is restricted from accessing properties of Identity-A. Linking can also be bi-directional such that Identity-A may utilize the properties of Identity-B and Identity-B may utilize the properties of Identity-A.

Messages sent using a linked property are sent in the context of the identity owning that property. For example Identity-A sends a message to a Group Identity owned by Identity-B, the message is sent in the context of Identity-B, as if the message was originating from Identity-B.

An example would be an individual Joe that has his own individual identity ‘joe’ as well as a managed identity ‘jsmith_co’ set up by his employer.
1. Joe creates an Identity Link from account joe to jsmith_co. He allows joe to see jsmith_co groups and users but not the other way
2. He has a communication method defined for joe, using his personal mobile number. He can send messages to both the groups under joe as well as under jsmith_co from his personal phone; policies enforced by IT admin for jsmith_co ensure that all messages for jsmith_co groups go out as having been sent by jsmith_co to ensure corporate compliance
3. Joe exposes his location field from account joe to his jsmith_co account so his company colleagues will know where he is if they need to. He updates his location periodically on account joe. Queries from his company colleagues to look for his location check the jsmith_co account, which looks at available Identity Links and finds the location under account joe.
4. Joe leaves the company. His IT admin closes jsmith_co account. Joe terminates the Identity link (as does the IT admin from company).

### 6.20. Identity Relationships

The system provides the functionality to manage numerous and complex relationships between identities. This provides a method for users to represent their human relationships in their communication identities.

The implementation provides for an unlimited number of relationships between an identity, and any other identity or Identity Group. Each relationship is unique containing a description of the relationship along with a list of the properties shared between the participants in the relationship. Each member in the relationship has access to the shared properties in the relationship.

The system is dynamic and extensible. The user can define relationship types. Once defined any two identities may establish that type of relationship. Once established by both identities, the properties listed in the relationship definition are shared between them. Any identity in the relationship may choose to end the relationship at any time, at which time the listed properties are no longer shared.

An identity in a relationship may choose to make one or all of the properties defined in the relationship private by setting the access privileges on those properties to ‘Private.’

### 6.21. Platform for Commercial Application Development

The system provides a framework of features that allows Commercial application developers to utilize the system as a platform for their own development of communication and social networking applications. The platform consists of a Web Services layer that provides access to the entire system. This access includes:
Secure access to the system
Ability to create, modify, delete and manage all types of identities
Ability to extend properties, and the command language for identities
Ability to establish Identity Links
Ability to define new Identity Relationship definitions and create Identity Relationships
Ability to access the Human Knowledge base and process the results of that access
Ability to dynamically receive messages and provide automated responses.
Applications are typically built by:
   Extending the command set
   Associate commands with services provided by the application developer—Smeak will invoke these when the commands are invoked by users
   Invoke services provided by Smeak to exercise Smeak functionality.

### 6.22. Intelligent Remote Message Processing

Separate from the application server, but integral to the system is a client component installed on the user's local system that can remotely receive messages, and perform functions based on embedded commands in the message. The commands follow the format of the command language that is integral to the system, and can be used to execute commands and programs on the local system. The message processor is extensible through the use user defined command handlers, allowing users to give the message processor the intelligence to process command extensions they have added to their identity.

In this implementation, the application server scans incoming messages and stores those messages whose embedded commands direct it to be routed for remote processing.

The remote processor, executing on the user's local system, periodically polls the application server on behalf of a specific identity to securely retrieve messages waiting for remote processing. Upon receipt of the message, the remote processor parses the embedded commands and takes the appropriate action. Some examples of the types of actions that can be taken are:
1. Request a file stored on the local machine be sent to a particular identity or group
2. Interface with a home automation system to enable some household device or function.

### 6.23. Message Identification and Authentication

The system includes a mechanism for providing additional security and user authentication on messages beyond that provided by the underlying mechanism. The mechanism utilizes a security control code embedded in the body of the message.

Users connect through the secure Web administrator to access their account and set a control code to be used for their messaging. Once set, the application identifies the user not only with the source address of the user, but also will verify the security code embedded in the message matches the one set by the user.

When setting up the security code, the Web Administrator will let the user specify where in the message to expect the security code and whether the code is required for all messages, or only for specific commands.

### 6.24. Impersonation of Users on Other Systems

In addition to providing a Smeak User Agent (SUA) that can relay messages sent to or by the User, it is own name, Smeak can also impersonate its Users directly on other systems. It does this by first requesting from the User his or her current User ID and password (if applicable) on the external system, and then logging into that system ‘as’ the User to send or receive messages. Thereafter, rather than getting a message from a User's SUA, a recipient can get it directly from what seems to be ‘the User.’ (Note: This could violate the Terms of Use of some systems, which may ask the User not to give his or her User ID and password to anyone else.)

More specifically, with respect to the main types of systems Smeak interfaces with:
1. Email. User enters his POP, SMTP, IMAP, or webmail account data into Smeak for each email account he or she wishes Smeak to manage. Smeak CMS can send and receive the User's email as if it were that User. Optionally it can (selectively) leave the email on an original server, allowing the user to additionally access their email via normal channels as usual. It might be preferable to leave work emails on an employer's server.
2. IM Systems. User enters his or her password along with their User ID on one or more IM systems. This allows the Smeak CMS to log on as that User and send and receive IM messages to/from any of the User's IM Friends. These messages will appear to come not from a SUA agent but directly from the User. In addition by this means Smeak can initiate interactive chat sessions, by (a) providing its own chat client and retransmitting the contents of the session to the User, or even (b) allowing the User to initiate an interactive chat session with his or her SUA that then routes an impersonated chat session to him or her via that or another IM system.
3. SMS. The User can input his or her password on their SMS system. To receive, upon the User's instructions or preferences, Smeak can dial in and set his SMS messages to forward to a Smeak-monitored SMS number. Afterwards the User no longer receives his or her messages, however they can (a) send Smeak an SMS message instructing it to turn such forwarding off, or (b) access their SMS system's menu and turn forwarding off manually. To send, on some systems it may be possible for Smeak to alter or ‘spoof’ its outbound SMS ID or number, substituting that of its User, thus sending out SMS messages that appear to come from the User.

Benefits of this methodology may include:
Messages ‘from the user’ will look nicer than from some user agent, by not being required to be in the (more complex, artificial) name of the SUA user agent
No need for every User to separately accept all of their Friends' SUAs as Friends.
No need to generate a Smeak based sub-id on each external system for each SUA, a process that could run afoul of those system's terms of use, and require Smeak to solve a CAPTCHA designed to prevent automated signups.

Disadvantages could include increased risks of sensitive account data being stolen and used to impersonate users for illegal or improper purposes, possible increased security costs for a riskier system, and/or possible blocking of Smeak's server addresses by other systems.

### 6.25. Credits

The System implements a bartering mechanism using an internal unit called a ‘Credit’. Users can acquire Credits in several ways:
1. Purchase them from Smeak (the ‘Primary Credit Market’)
2. Purchase them for a System-defined lesser cost from another User (the ‘Secondary Credit Market’)
3. Earn them from Smeak by referring other Users
4. Receive them as a gift from another User, such as a parent
5. Earn them from other Users in exchange for services such as viewing Advertisements.

Users can apply Credits in several ways:
1. Use them to purchase premium features from Smeak (e.g., an extra identity beyond those initially supplied to Users, or a premium account such as a managing account)
2. Use them to incent other Users to perform services such as viewing Advertisements.
3. Sell them on the Secondary Credit Market for purchase by other Users.

The Credit system is intended as an incentive mechanism to Users to conduct activities that expand the System and its business while minimizing the involvement of real money. Thus a User could earn Credits by referring other Users or viewing appropriate Advertisements, and use those Credits to pay the System for premium capabilities, all without ever converting Credits to and from real money.

### 6.26. Advertisements

Existing internet-based advertising is based on concepts of ‘critical mass’ and probabilities. Thus the premier sites for advertisers are those with many millions of viewers, with probabilities and likelihoods influencing advertising returns. An advertiser placing an Advertisement on such a site expects returns in the form of ‘clicks’ or views of the Advertisement. Advertisers still cannot be sure whether the ‘click’ represents a truly qualified recipient.

By using concepts presented in the earlier sections of this document, Smeak is able to uniquely provide a significantly better return for advertisers. The fundamental concepts used include:
1. Recipient control: Smeak Users control the criteria and mechanism for receiving messages. Thus a User can specify that they are interested in seeing Ads about gardening equipment and would like to receive it at a specific email address, but only until a certain date and only if compensated by the advertiser with some number of credits. Only Ads which satisfy these criteria will make it through to the User's purview.
2. Preservation of Anonymity: By choosing to receive Ads as described, the User does not put their subsequent privacy at risk. The User can choose to expose a temporary identity only, for example, to the Advertiser; and even this temporary identity is protected by the Recipient controls as in item 1. Thus, freed from the worry of subsequent bother by loss of privacy, Users will be able to genuinely shop for items of interest and be rewarded for these efforts to boot.
3. Unique Recipient Identification: The System is able to uniquely identify every User of the System, and is thus able to provide the Advertisers with information on whether the Ads were sent and viewed by unique, qualified, self-identified individuals, along with relevant statistics.

Users who are interested in receiving Ads join public Groups provided by the System. They create rules to specify the criteria under which they would like to receive messages sent to them as members of these Groups. For example, User A joins the Group ‘Ads’ and sets rules that he is interested in Ads sent to this group which have the keywords ‘Gardening’, until a particular date, if paid at least 2 Credits for viewing the Ad, and would like to see such Ads sent to a particular email communication method.

Advertisers set up their Ads to be sent out as per certain criteria. For example, Advertiser B sets up an Ad, to be sent out on the first of each month, to Users interested in ‘Gardening’ or ‘Hardware’, provided the User has never been sent this Ad before, and authorizes a payment of 2 Credits if the User views the Ad. On the first of the month the System sends the Ad to the specific Users who satisfy the criteria. As long as the Advertiser has sufficient Credits available, the System pays the Users who view the Ads the appropriate amount from the Advertiser's account. In order to obtain such Credits, the Advertiser buys them from the Secondary Market (other Users) first, as the price is lower for those Credits, and buys the remainder from the System (the Primary Market).

The Advertiser can also choose to request an acknowledgement from the viewing User in order to consider the Ad as received. Unlike traditional Internet methods that involve the User having to click on the Ad—thus exposing them to potential computer viruses—the Smeak System asks the viewing User to reply to the Ad. The Smeak System will appropriately handle this reply and the Advertiser will receive the acknowledgement without compromising safety or privacy.

The same process works if the User requests an Ad via a message qualified by a command requesting the Ad with specific criteria. In that circumstance, if the Advertiser has defined the Ad appropriately to respond on request, The System will find the appropriate Ad and respond to the User.

### 7. DETAILED DESCRIPTION

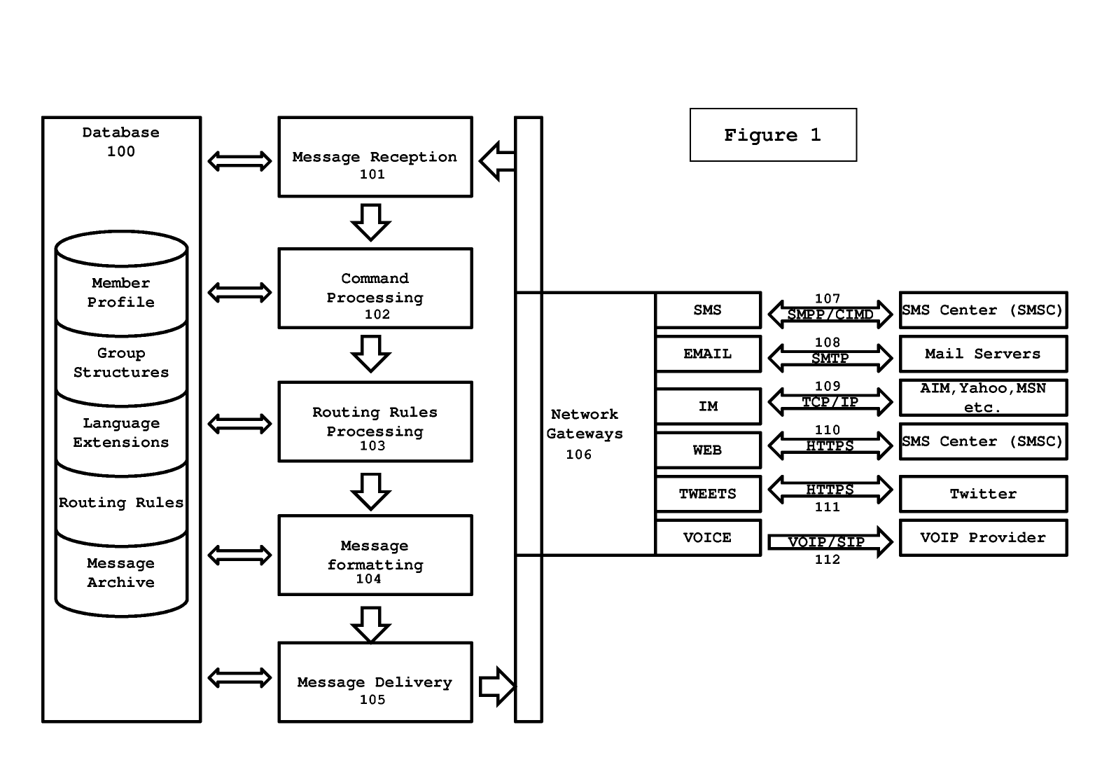

Turning to FIG. 1 we see a the components of the core application server, including gateways, and the flow of messages through the system. A database 100 contains at least the system's member profiles, group structures, language extensions, routing rules, and message archive. A series of computer implemented processes handles reception of messages 101 from external communication systems, command processing 102 e.g., the parsing and execution of Smeak commands detected in messages, a process 103 to lookup and execute user or system defined routing rules, a message formatting engine 104 to convert messages to and from the formats required by different systems, and a message delivery queue 105 to transfer outbound messages back to their destination communication systems. A suite of network gateways 106 is provided to handle the sending and receiving of messages via various electronic communication means, including SMS over SMPP/CIMD 107, Email over SMTP 108, IM over TCP/IP 109, web pages and tweets over HTTPS 110, 111, and voice over VOIP/SIP 112.

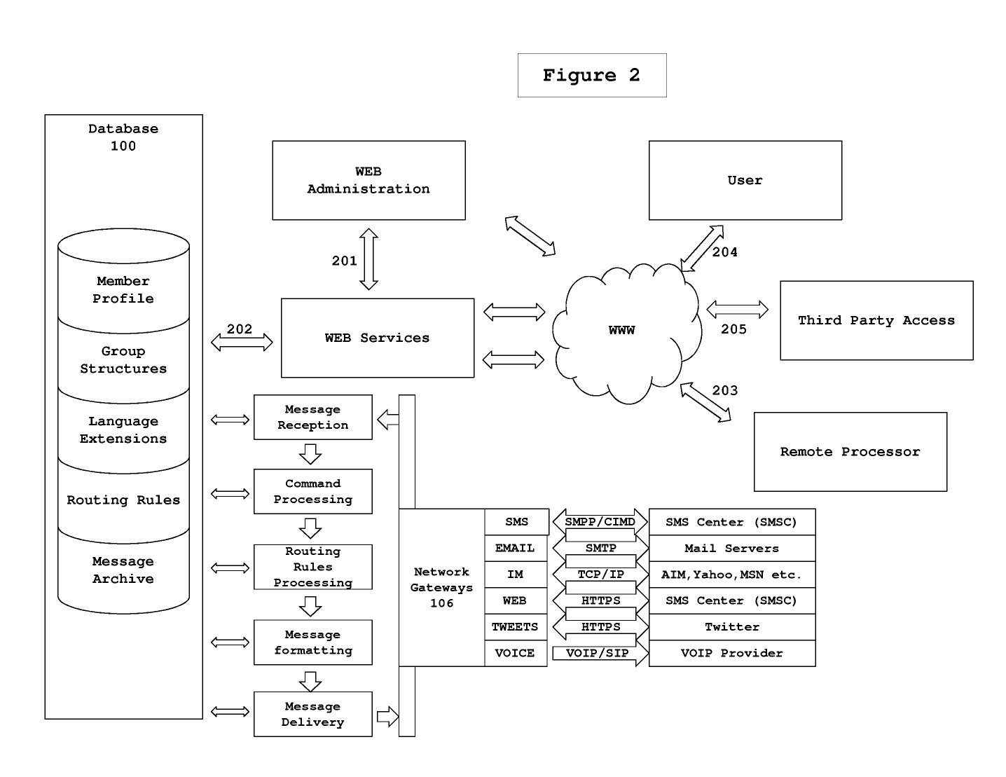

Turning to FIG. 2 we see the same core application server components depicted in FIG. 1, plus additional system components including the Web application, Web services component, and remote command processor. A system administrator interacts 201 directly with the system via web services, which in turn convey instructions to the system via database updates 202. Additional parties including users 204, third parties 205, and remote processes 203 interact remotely with the system via web services over the Internet (WWW).

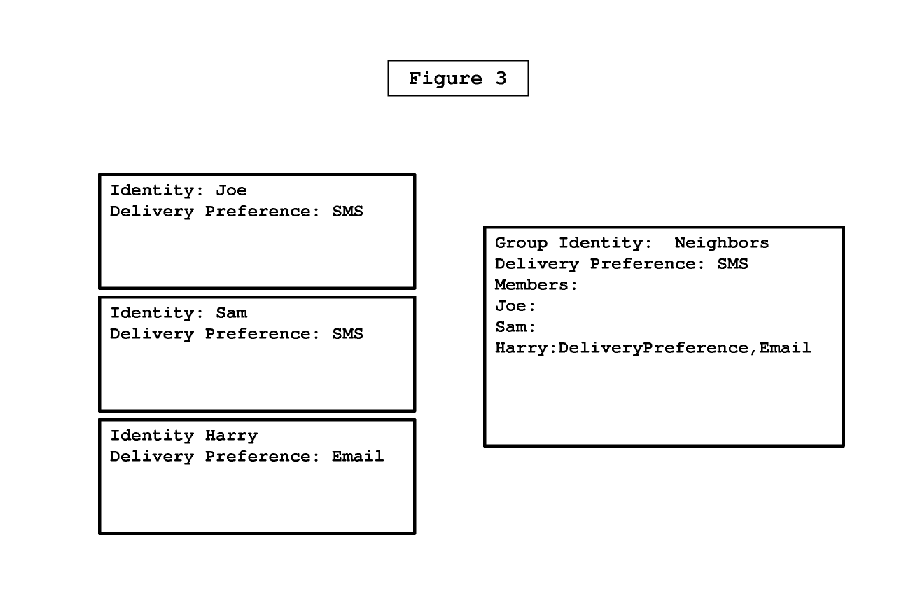

Turning to FIG. 3 we see a set of system Users who have pre-defined their delivery preferences, and their unification (by another User) into a Group with a default delivery preference.

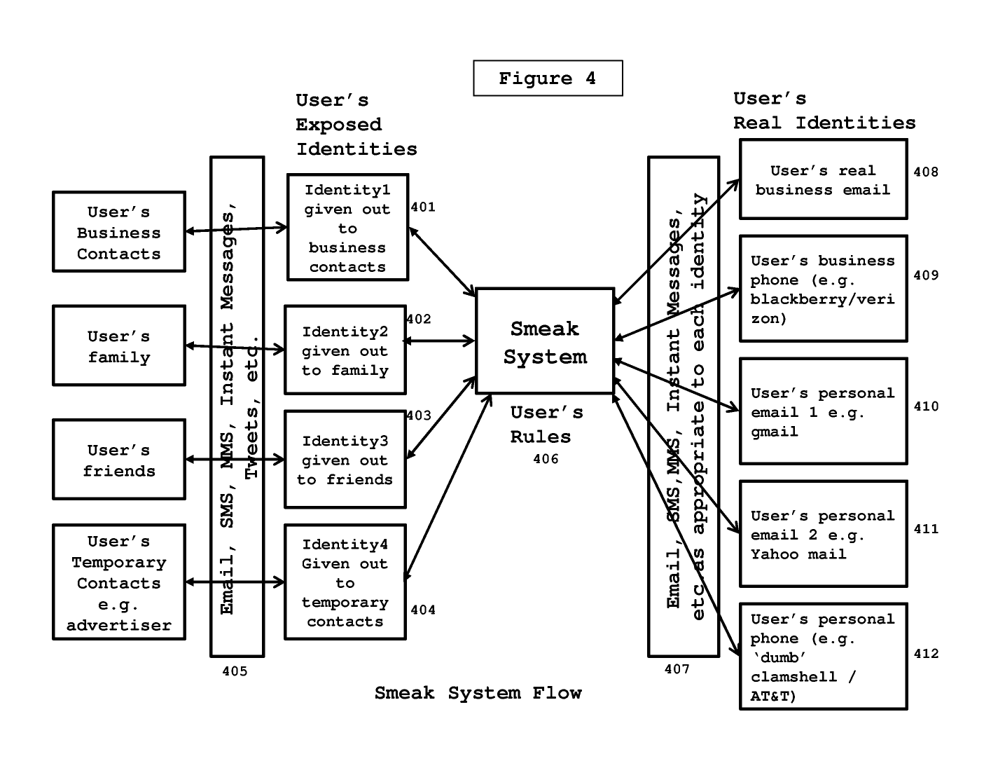

Turning to FIG. 4 we see a generalized system flow diagram showing how the system allows a User to create communication aliases 401-404 for different external groups or audiences, send and receive messages to and from those contact groups 405, establish a set of personal routing and processing rules 406, and then route the resulting communications 407 to and from his or her personal communication accounts 408-412.

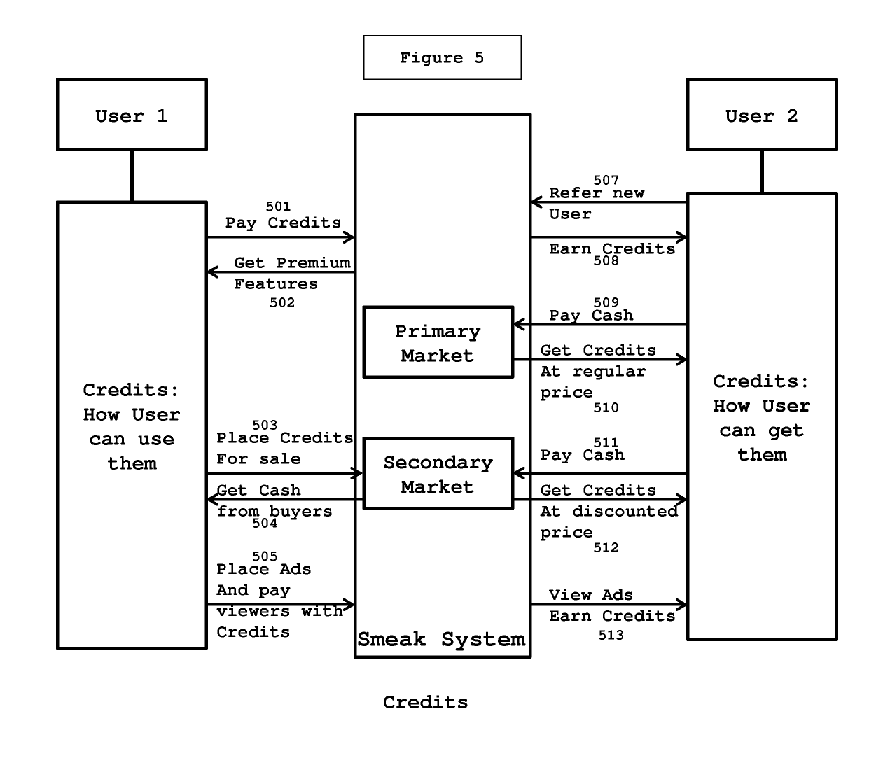

FIG. 5 is a generalized system flow diagram showing the primary operations to manage credits among and between the system and its users. A User2 can earn system credits 508 by referring a new user 507, receive regular price credits 510 by completing a cash or credit card payment 509, purchase (discounted) credits on the Smeak secondary market 512 for cash 511, and earn credits by viewing ads 513. A User1 can pay credits 501 for access to premium features 502, sell credits on the Smeak secondary market 503 and receive cash from buyers 504, and pay users for viewing ads 505 he or she places.

A more detailed narrative follows. User1 has 100 Credits. User2 has no Credits. Note: actual numbers in example below may vary in implementation (e.g. cost per Credit, referral bonus etc.)
501: User1 uses 10 Credits to purchase 5 new aliases, and 10 Credits to pay for a month of a Family Account. System moves 20 Credits from User1's account to System's account.
502: User1 gets the premium features enabled. User1 now has 80 Credits.
507: User2 refers a new User.
508: System pays User2 10 Credits for the referral. User2 now has 10 Credits.
509: User2 buys 20 Credits from Primary Market. Primary market cost per Credit is $0.50. System moves $10 from User2's account to System's account.
510: User2 is paid 20 Credits by System and now has 30 Credits.
503: User1 places 20 Credits for Sale on Secondary Market.
511: User2 pays cash to buy the 20 credits. Secondary market cost per Credit is only $0.30. So User2 pays $6.
504: System moves $6 from User2's account to User1's account.
512: System moves 20 Credits from User1's account to User2's account. User1 now has 60 Credits.
505: User1 places an Ad for viewing, promising to pay 5 Credits to appropriate Users who view the Ad.
513: User2 views the Ad, and the System moves 5 Credits from User1's account to User2's account. User1 now has 55 Credits and User2 has 35 Credits.

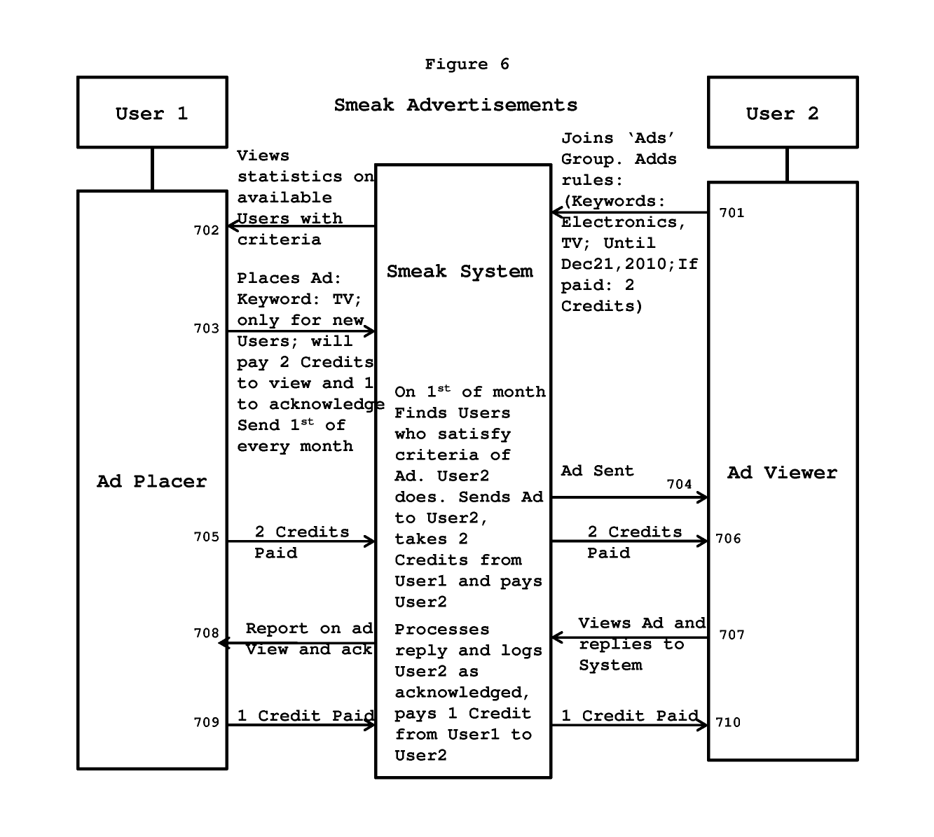

In FIG. 6 we see the primary operations to manage advertisements among and between the system and its users. User1 is an Advertiser. User2 is a User who is interested in viewing Ads. Note: Actual numbers in example below may vary in implementation.
701: User1 wishes to view ads on TVs, as long as he is paid for his time. In the Smeak System he can only be contacted if he wishes it (Recipient Control). User1 signs up to receive eligible ads by joining a group ‘Ads’ and setting up rules for messages he gets as a member of this group: that they should be about TVs (by having the Keyword ‘TV’ or ‘Electronics’), that they should be only until a specific date/time and that he should be paid at least 2 Credits for his trouble.
702: User1 wishes to advertise TVs. He sees on the system that there are multiple Users like User1 who are interested in TVs if they are paid to view the Ads.
703: User1 is willing to pay 2 Credits for someone to view the Ad, and 1 more Credit if they acknowledge viewing it. He places the Ad with the System, sets up a Keyword ‘TV’ for it, and agrees to pay as stated. He adds a constraint that he would like Ads to only go to new Users (who have never seen his specific Ad before) and rules on when the System should send out the ad (first of each month).
704: On the first of the month, the System sends out the Ad. User2 is a qualified recipient and receives the ad.
705, 706: The System moves 2 Credits from User1's account to User2's account.
707: User2 does not need to ‘click’ on the Ad (which could be dangerous) to prove receipt; rather, he replies to it and the reply goes to the System.
708: The System provides reports to User1 that User2 has acknowledged receipt.
709, 710: The System moves 1 Credit from User1's account to User2's account.

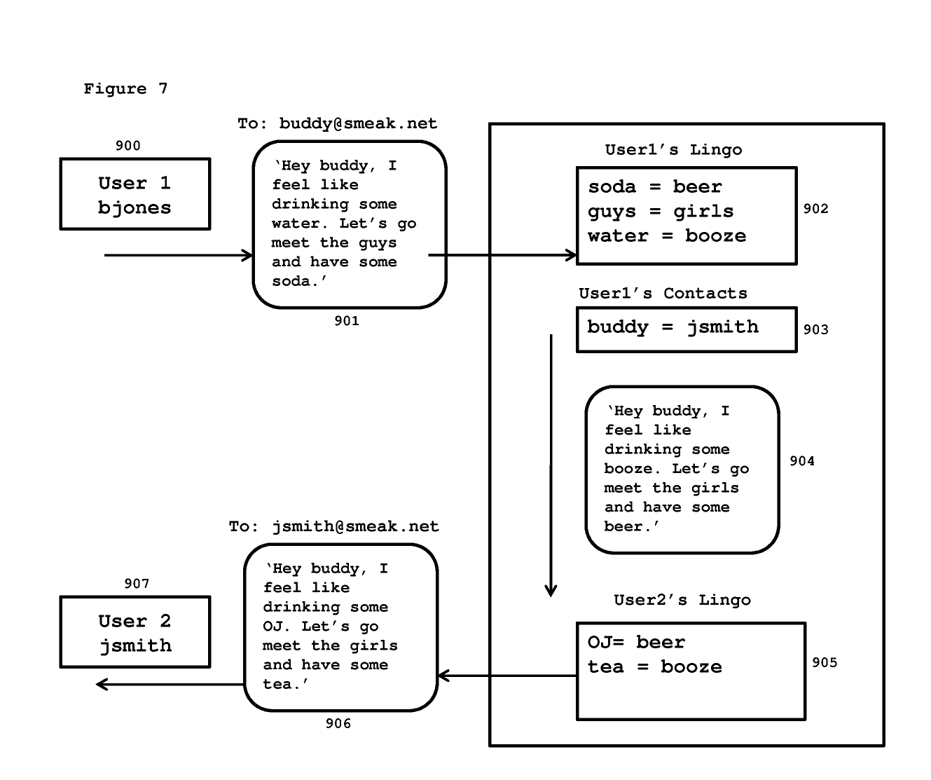

Turning to FIG. 7 we see a flow diagram showing an example of the use of Smeak Lingo to encode and decode messages using a user definable dictionary. User1 900, whose UserID is bjones, and User2 907, whose UserID is jsmith, are friends. User1 wishes to communicate sensitive information to User2, but does not wish certain compromising words stored in his phone, where his girlfriend could see them. User2 has similar concerns. Both User1 and User2 have used Smeak Lingo to define meanings for certain code words they wish to use. Each of them has their own code words for certain words that they deem sensitive.
901: User1 sends a message containing the words, ‘water’, ‘guys’, and ‘soda’. User1 has also defined ‘buddy’ as the nickname for his friend ‘jsmith’. When he sends a message to ‘buddy@smeak.net’ from his phone, anyone casually looking at his sent items does not know to whom he sent it.
902: User1's real meanings for these code words are the words ‘booze’, ‘girls’, and ‘beer’ respectively.
903: The System finds that User1's ‘buddy’ is ‘jsmith’ who is the addressee
904: The System ‘untranslates’ the message internally into its true meaning.
905: The System now finds that jsmith, User2, also has a dictionary of code words. Here the word ‘beer’ is encoded to ‘0J’ and ‘booze’ to ‘tea’ but there is no code for ‘girls’.
906: The System translates the message to jsmith's code and sends it on to him.

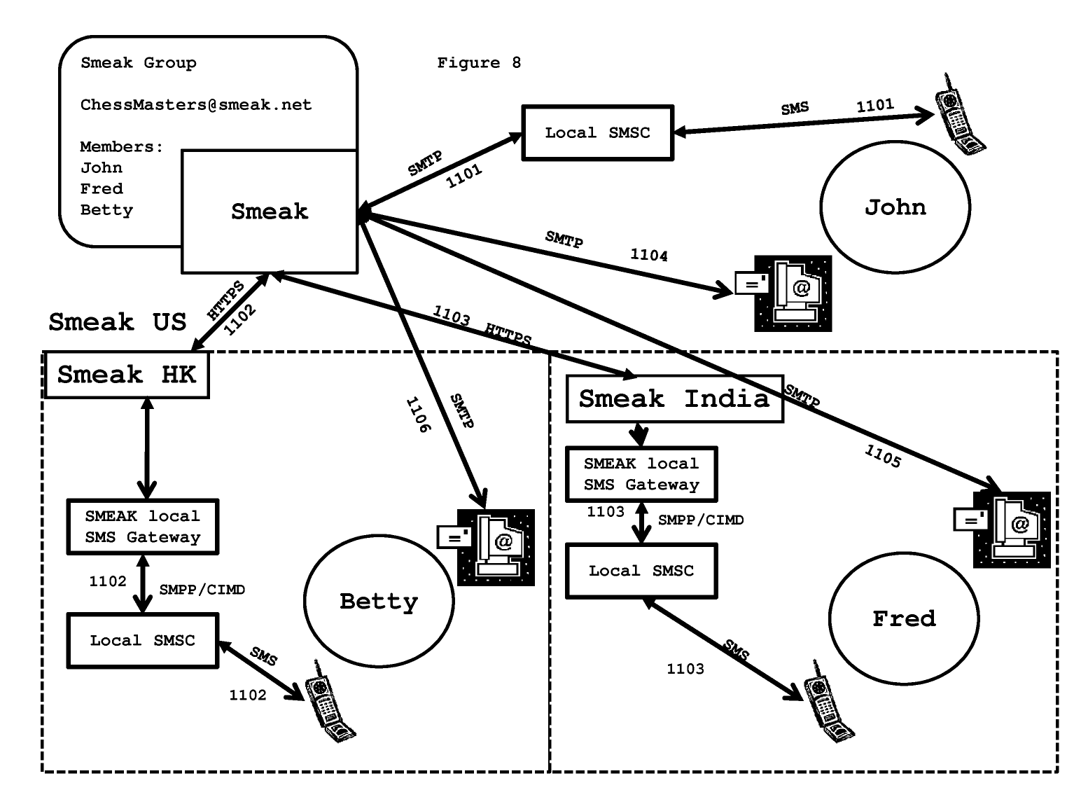

Turning to FIG. 8 we see an example of the paths taken by a message sent by a User to members of a Group who have selected varying delivery preferences. John sends a group message 1104 to the Group ChessMasters@smeak.net from his email client.

Smeak routes the message to the members of the ChessMasters group, using the routing rules specified. The message is routed to the mobile device of member Betty in Hong Kong via a message 1102 to Smeak's local SMS gateway in Hong Kong. The message is also routed to member Fred in India whose routing rules specify an email delivery 1105.

Member Fred replies to the message using his email client. The message is routed 1105 to Smeak and Smeak distributes the message to the members of the chess masters group. Member John has routing rule that specify messages be delivered both to his Email 1105 and mobile device 1101. The reply is routed to the mobile device of member Betty in Honk Kong via a message 1102 to Smeak's local SMS gateway in Hong Kong. She can also receive it by SMTP 1106.

Member John replies to the reply from member Fred using his mobile device (Path 1101). Smeak routes this reply to the members of the group. The message is routed to the mobile device of member Betty in Hong Kong via a message 1102 to Smeak's local SMS gateway in Hong Kong. The message is also routed member Fred in India whose routing rules specify an email delivery 1105.

### 8. INNOVATIVE FEATURES

This section lists and discusses features of the Smeak system that are believed to be innovative.

General: The Smeak System extends across ecosystems, e.g., across multiple Email providers, phone providers, and chat system providers. Similar features are sometimes available, within one such ecosystem. For example, Yahoo! Email offers multiple aliases for paid accounts, which divert email to specific folders WITHIN Yahoo! Email; whereas Smeak aliases are across any Email or phone provider. Similarly, iPhone chat applications work between iPhones; Smeak group chat works across any Email or phone provider.
1. Control of Messages
   a. Ability for a user to control how a message is received, regardless of how it was sent
      i. E.g. message sent by text but received by user on email
      ii. E.g. message sent by email but received by user on text
   b. Ability for a user to control where a message is received
      i. E.g. message is directed to specific email addresses of the user, or phone numbers of the user, or combinations thereof, depending on criteria
   c. Ability for a user to control if a message is to be received at all, depending on message criteria
   d. Ability for a user to control format of a message received, depending on criteria
   e. Ability for a user to control when a message is sent to him/her regardless of mechanism of message sending (i.e. whether it was a text or email sent to him).
   f. The rules governing incoming messages include each of, and combinations of the following, such combinations including ‘AND’ and ‘OR’ qualifiers:
      i. Sender criteria: Specific Smeak Identity, Email address, or phone number, or Smeak membership criteria (member or non-member)
      ii. Recipient criteria: Whether received because message is sent to a group of which Recipient is a member, or sent directly to a specific externally exposed Identity of the recipient
      iii. Recipient properties criteria: Whether the recipient has certain properties such as current location, food preferences, interest in certain areas specified by keywords (e.g. gardening, electronics)
      iv. Message criteria: Whether the message has certain criteria as qualified by properties as described in item 3.d.
      v. Time criteria: Whether the message is received after a particular time or between certain time periods
      vi. Mechanism of incoming message: Whether the message is originally sent via text SMS, or text MMS, or email, or instant message etc.
      vii. Structure of message: Whether the message contains attachments of specific kinds
   g. The actions performed on such incoming messages are based on the rules as described in 1.f, and include:
      i. Reject the message with or without a response
      ii. Send the message to one or more communication methods (including SMS, MMS, email, Instant message, Tweets etc.), such methods belonging to one or more user accounts (e.g. if a message with a picture is received or sent by my son's account via MMS or email, send a copy to my email address; if a message is sent by my wife, regardless of whether she sent a text or email, send me email to my gmail address and send a text message to my mobile phone)
      iii. Depending on the mechanism of receipt (e.g. my cell phone via SMS) format the message appropriately (e.g. send only the subject, or only N characters, or split the message into multiple messages until the entire message is exhausted etc.)
      iv. Send message out via any of user's registered Identities. The user can choose any of their disposable identities as the sender of the message, masking their real email or phone identities.
      v. Send message out via a particular communication method depending on the number of messages per time period sent through that method (e.g. no more than a certain number of text messages per month)
2. Unification of messaging communication (no comparable mechanism is known to exist)
   a. A user may have multiple email addresses from multiple providers, as well as multiple phones. With the Smeak system, while continuing to have all these identities, the user can have the convenience of providing a single identity to his/her communication partners, and use rules as described in section 8.1 to route the messages to each of the real email/phone/other identities.
   b. Recognition of user: When a user sends a message via the Smeak system from any of their registered communication methods (such as email addresses or phone numbers) the System recognizes the message as coming from that single user entity and executes that user entity's rules as in section 8.1.
   c. Protection around recognition: The user can protect the above recognition through added code characters within the body of their message, so that their address cannot be spoofed by a rogue party.
3. Multiple disposable identities for different communication partners (no such known mechanism exists across ecosystems)
   a. Email accounts and phone numbers are precious identities. Users become dependent on them and they are difficult to change. Once users have to give out this information to others, they expose themselves to be contacted outside of the original intention, and by users other than the person to whom they gave out the information. The convenience of mobile phones is sometimes an inconvenience when an undesirable person gets hold of the number.
   b. The innovation of multiple disposable identities provided by Smeak solves the problem in 1a for all messaging identities, by providing disposable identities, which can be given out to different groups of people in different circumstances by a user. These identities can then be controlled by rules as described in section 8.1 to route messages to the real Email and phone identities. These identities thus mask the user's real and less disposable Email and phone identities. The identities can be configured by rules to reject undesirable messages, and in the worst case can be deleted without loss of any information (unlike real Email and phone identities).
   c. This mechanism is available in Smeak without a dependency on a specific Email provider or phone provider, but across all such real identities.
4. Commands
   a. Commands are instructions to the System and follow a <name><valueset> structure. They help provide qualifications to the message and can be used to control properties and rules of the User's communication. They allow users to command a powerful central system from any device via messaging.
   b. In line: Smeak commands are in line anywhere within a message. Other systems with commands require the entire message to be a command or a require a command to be the beginning of a message. In Smeak a command can be anywhere within a message, and that message could be a communication to another user. The command is recognized as an instruction and taken out of the message.
   c. Any communication method: Smeak commands can be sent from any method of communication including email, text, etc. Most systems that implement any such mechanism only do so for very specific communication methods.
   d. Qualify a message with properties: Smeak commands are utilized not just to instruct the system to perform actions, but also to qualify messages with properties, such as priority, keywords, request return receipt, etc.
   e. Extensible: Smeak's command system is extensible and users can add their own commands with actions to be executed upon invocation. Once added any user of the system can use such commands. Other systems that have commands are not extensible in this manner.
   f. Examples of commands include and are not limited to:
      i. Set location of this user (location)
      ii. Get location of a user (specify the user and system returns the location if permissions allow)
      iii. a Request return receipt
      iv. Set priority (high, medium low)
      v. Set keywords for this message (list of keywords)
      vi. Help me (sends request for help message to a pre-defined group of friends)
      vii. Command help (requests list of commands and params or help on a specific command)
      viii. Ad request (request a service in a particular area)
      ix. Send a document, filling in fields with command parameters (e.g. the command phrase ‘!send-doc,docname,John,Smith’ will send the document called ‘docname’ that has been uploaded to the user's account on Smeak, changing all occurrences in that document of ‘%1’ to ‘John’ and ‘%2’ to ‘Smith’)
5. Group Chat:
   a. Group communication (where a person sends a message to a group and recipients of the group can respond to all recipients) is today limited in scope, especially for text messaging. When a text message arrives, it normally has no knowledge of other recipients. Communicating with multiple friends via text messages thus involves many individual messages with loss of context and added costs. Existing means of addressing this involve phone-specific applications that enable such communication only between participants who all have such phones; other mechanisms that provide some form of intermediated group chat are restricted to geographies or only to text.
   b. Smeak is unique in providing group communication across text and email, unrestricted to geographies. Thus a user in the USA can communicate with a user in India via text and with another in Hong Kong via email by sending a single text message using Smeak.
6. Lingo:
   a. As the use of devices such as mobile phones increases, these devices present a security risk of unauthorized or undesirable people to look at the devices. ‘Smart’ phone devices have emails in them, in the inbox and sent folders. All phones that use text have text messages in Inbox and sent folders. These can contain information that is compromising, or a security risk, or otherwise not for consumption by unauthorized parties.
   b. Smeak Lingo uniquely addresses this. A user of Smeak can define a unique dictionary specific to themselves only, with code words matching specific words. Messages to and from Smeak from the user (regardless of means of communication) that contain those code words will be translated by Smeak to the real meanings by using the user's private dictionary. Thus a user can define the word ‘water’ to really mean ‘beer’. A message sent by this user with the word ‘water’ in it will cause Smeak to translate that word to ‘beer’ in the message. A user receiving this message may also not wish to have the word ‘beer’ on their communication, and can define it to ‘soda’. Thus when the first user sends ‘water’ the second will get ‘soda’ and both will know it really means ‘beer’ although ‘beer’ does not appear anywhere on their devices.
   c. Similarly, a Smeak user can define a nickname for any contact they communicate with. Thus a user could have the nickname ‘Joe’ for someone who is really ‘Jill’. Messages to and from the real ‘Jill’ will appear as to and from ‘Joe’ to anyone who casually examines the user's inbox or sent items.
7. Credits
   a. Various existing systems have private currencies or ‘Credits’. These are typically used as rewards that can be redeemed from the system.
   b. Smeak extends this concept uniquely by not just providing Credits as rewards, but using it as a complete currency between users.
   c. Users can incent others to view Advertisements or perform certain services in exchange for Credits.
   d. Smeak also implements a ‘primary market’ where Credits can be purchased from Smeak, and a ‘secondary market’ where Credits can be purchased from other users at a lower cost. This incents users to earn Credits as rewards, as these can be sold to other users for cash. The secondary market will be sold out first because of the lower cost of Credits there.
8. Smeak Advertisements
   a. Unique mechanism to identify individuals who are interested in specific items
   b. Recipient control ensures that the individuals can only be reached according to their criteria, and cannot be subsequently spammed
   c. Recipient can thus specify criteria including payment terms in order to view an Advertiser's ad
   d. Advertiser can be assured of reaching such individuals at a fixed, predictable cost and prove that a self-qualified individual has been reached with a specific Ad at that cost.
   e. This mechanism is vastly superior in ROI over hit-and-miss systems that require enormous ‘critical mass’ before reaching qualified individuals, which can still not prove that a qualified individual has been reached except statistically.
   f. The Recipient control ensures that the Advertiser cannot subsequently spam the user. The knowledge of this control gives the user confidence to conduct further eCommerce via this mechanism.
9. Family Controls
   a. Special family ‘Group’ with a family friendly name and extension e.g. ‘smith.family’ with ability to create identities with this suffix (e.g. joe.smith.family@smeak.net) allows family members to retain their various real identities but use a family-friendly unifying identity.
   b. Messages to the ‘Group’ e.g. to smith.family@smeak.net will be governed by family-level rules and route messages appropriately. This provides a ‘family identity’ for the first time.
   c. Premium ‘managing’ account provided for parents and ‘managed’ accounts for children. Allows ‘managing’ account to control the ‘managed’ accounts, for purposes such as:
      i. Getting copied on text messages, especially those with pictures
      ii. Ensuring total number of text messages in a time period is not exceeded
      iii. Ensuring no text messages during school period
      iv. Ensuring approval needed for a new contact, or at a more lenient level, a notification on each new contact added by a child
   d. These capabilities provide features that do not exist in other systems for parental control over children.
   e. Shared features such as Lingo, locations, bulletin boards, for the family account, enabling capabilities that do not exist in any comparable system
10. Business Usage of Text
   a. Business systems that address needs of mobile workforces are very expensive, have device limitations, and are designed for large corporations.
   b. No mobile business system exists to address the majority of businesses, which are small.
   c. Smeak provides business systems that:
      Enable employees to share information as closed communities with structured and directed communication with recipient control modulated by managed control for text and its unification with email.
      Provide a messaging electronic secretary to control communication into the business.
      Provide Fundamental capabilities to a small and mobile work force, such as work-orders, contract communications, service fulfillment, invoicing from rudimentary mobile devices using text.
      Provide multiple virtual identities, giving the ability for a small business to appear larger and more organized than reality (e.g. customer service, sales and other departments for a one-man operation), as well as the ability to handle incoming ads, partner with other businesses and so forth via appropriate external appearances.
      Provide the ability to hide internal changes or internal contact information. For example, doctors do not like to give out their phone numbers or real email ID. By using Smeak, a doctor could setup addresses for patients to report problems, request prescriptions etc. Depending on the patient the information would be forwarded to the Doctor (e.g. high-risk patient may rate a text to the Doctor while he is on his golf course whereas others may not). The prescription request address could, depending on the patient, cause a prescription refill request to be submitted to a pharmacy and the information logged, all without the Doctor needing to do anything.

Business oriented capabilities provided by Smeak include:
Administrator accounts and regular (managed) accounts. In any business situation, IT administrators need to be able to control, set rules for, and delete employee accounts. This capability to manage unified communication including mobile numbers, without needing to purchase a mobile provider plan but using existing employees' personal phones, does not exist in the industry.
Group-wide and company-wide rules with group manager capabilities: Ability for business leaders to set up business compliance and legal compliance capabilities for their teams for all communication media. Thus a sales leader should be able to have any texts sent to and from his sales team to be cc-ed to an email address for example; the company could institute a rule to have only email sent out of the company, with appropriate signature guidelines, regardless of whether it originated as a text—i.e. a customer contacts a rep, which causes Smeak to the rep's phone. Rep responds via text, the system sends it to the customer from the rep's email, with company signature etc. and appropriate audit. Such text audit does not exist in the industry.
Compliance and Audit. Ensuring that text by employees is audited according to compliance policies is important for businesses and there is no general cost-effective solution in the market, and no solution for text from personal employee phones outside of Smeak. Smeak business accounts allow for cc of all text to centralized or distributed corporate email addresses or Smeak IDs on non-Lingo-translated or Lingo-translated basis.
Business aliases. Disposable identities at a corporate level.
Work-orders, contracts, invoices, and fulfillment tracking.
   Work-orders: The differentiators with Smeak are that work-orders can be initiated from a text or email (via command+send file with variable substitutions) to appropriate workers depending on rules, with audit/copy and tracking; Work orders will reach workers depending on how they want to be reached, and they can query information via text.
   Invoices: A one-person business on the road can generate an invoice with a simple text, using send file with variable substitutions.
   Contracts: Contracts can be filled in and sent to customers without needing to be in front of a computer, using means similar to the above.
   Fulfillment tracking: Upon completion of work, simple text by workers can set work completion status, trigger invoices and so forth.
   All of the above and adjunct capabilities will have audit/copy and tracking. In addition, business accounts can set up web services to invoke upon the above input actions, which will perform integration with other business applications.
SELF-links: As described above, Smeak business accounts help enforce compliance and business rules. The business employee with this business account may only choose to bind their business email to this account (as it is only valid during their tenure of employment with that firm). The personal phone and email of the employee may be bound to their personal account. In such a scenario, it would be useful and sometimes essential for the employee to be reached on a personal phone in a business context and be able to respond in a business context. To do this, business accounts provide SELF-links which allow the Smeaker to link up the business account with their personal account, and to choose which elements are exposed to the other account from either account. A Smeaker sending a message to a business contact from the personal communication method will then traverse the SELF-link and send via the business account, following all business rules.
11. Public Groups
   a. Smeak members become part of a group whose name is globally known in the Smeak Domain. Members will receive messages addressed to the Group, and can send messages to all members of the group.
   b. Participation in public group communications is controlled by the Smeak member
12. Human Knowledgebase
   a. Smeak members can participate in public groups that are essentially a Human Knowledge base. Members register with the group and provide keywords listing their location, interests etc. Questions may be sent to the group, along with keywords to limit the scope of the search.
   b. Smeak will route the questions to participants with the best keyword matches.
   c. Answers sent in the replies to the message are routed back to the sender, or can be compiled into a survey result summary (e.g. 1,543 responses, 52% yes, 14% no, 34% unknown)

### NEW MATTER

### 9. USER ACCOUNTS

The Smeak system provides the unique capability for a non-user to create an account merely by messaging the system, using email, SMS, or equivalent messaging. An account can also be created via conventional web-based sign-up mechanism. Upon account creation, a unique Smeak User ID is provided to the User as a Pseudonym or ‘Virtual Identity’ to the user account. The user can create additional Pseudonyms that refer to their user account, using either a web-based mechanism, or by sending command messages to the system. These Pseudonyms can be deleted without the user account being deleted, as long as at least one Pseudonym remains for the user account.

Smeak CMS implements this capability via the system shown in FIGS. 1, 2 and 4. To join Smeak, a user merely messages to the Smeak ID “join” with the body of the message containing a single word representing the ID or Pseudonym requested.

Smeak can be reached via email gateways, or via SMS numbers. In the United States, all SMS carriers have email gateways, and hence a message to an email ID can be sent from a phone via SMS. Thus in the United States, and in countries where this capability is available, the user would message to join@smeak.net or an equivalent reserved address from a phone or a regular email system. The body of the message would contain (e.g.) “Frank” if the id requested is “Frank”. In countries where SMS to email is not available, a text message would be sent to a number provided by Smeak, with the line “to,join” as the first line and “frank” as the second line, for example.

The Smeak CMS maintains all Pseudonyms as globally unique entities in its database. However, each such Pseudonym can only be associated with a single User ID (which is not revealed to the user explicitly). There can be many Pseudonyms associated with this same User ID. Upon receiving the message to its “join” User ID, the Smeak CMS does the following:
1. It matches the from address—whether an email address or a phone number—to see if a User ID already exists in the system that is associated with this from address.
2. If such a User ID exists, the system checks if the User ID belongs to a registered user, or to a user who has communicated via the system before (a non-User). See the section below on Non-Users for more details.
3. If the User ID is a non-User, the Smeak CMS will re-use the previously created non-User structure and ‘promote’ it to be a user (who has now formally joined).
4. If the User ID exists and is a valid user, then the system returns an error, as you cannot join twice from the same from address.
5. If the User ID does not exist, the system then checks if the requested Pseudonym or Virtual Identity exists in the system. If such a Pseudonym exists, the system creates a unique Pseudonym by using methods such as adding numbers incrementally to the requested Pseudonym until the next available unique Pseudonym is found. Thus if “frank” was the requested Pseudonym, but “frank” already exists, and so does frank1, frank2, et al, the system may return frank52 for example, if that is the first available unique Pseudonym.
6. The system either re-uses the non-User record structure from step 3, or creates a new User ID as in step 5, and assigns the appropriate Pseudonym to it, and returns that Pseudonym to the requester with appropriate instructions including a password. These instructions inform the new user to visit the web site and complete their validation (e.g.) within a certain probationary period. During that period, the user may use Smeak, but will need to complete the validation or the User ID will expire at the end of the period.
7. A similar mechanism is available to new users who wish to join Smeak from its web site. In this case, a user does the following:
   The user requests a new account, and must associate an email address or a phone number with the account, as well as set a password.
   The Smeak CMS sends a verification message with a number in it to that address (also known as a “communication method”). The user must then type in that number and reply to validate that communication method.
   The user can continue to add communication methods to their account, whether the account was created via messaging or via the web.

### 10. MESSAGE-BASED MANAGEMENT OF MULTIPLE PSEUDONYMS

As described earlier, a user account can be associated with multiple real email addresses, phone numbers and other such real identities of the user. Several providers have implemented systems that provide multiple pseudonyms for a single account, and multiple pseudonyms for several of their own email accounts. However, the Smeak CMS is unique in the ability for a user to create multiple pseudonyms to a user account that in turn can refer to multiple, heterogeneous accounts, which can be email, phone, instant messaging, or other identities; and also in the ability to create and manage such pseudonyms via messaging.

This is implemented using the following mechanism. As described above, the user can add virtually any electronic communication method to their account. Hence the capability of the system to retain multiple, heterogeneous communication methods (i.e. phone, email systems from multiple providers). The ability to associate multiple pseudonyms with a single account, the mechanism is implemented both via the web and via messaging, as follows.

The Smeak CMS provides restricted or system addresses such as “Agent” or “Smeak” which accept commands. As described above, Smeak can be reached via email or via SMS. In the email situation, these restricted addresses will be like agent@smeak.net or smeak@smeak.net. In the SMS situation, the SMS message will contain the first words as “to,agent”. Messages to these restricted IDs will be assumed to be commands, with a syntax as described below in the section “General Command Structure”.

A command to add a Pseudonym is of the form “add,alias,frankie”. The system interprets this as a command to add the Pseudonym “frankie” to the user who sent the message. The system will identify such a user by using the email “from” id or the phone number the message came from.

As before, the system searches through its database to see if the from ID already exists. If so it checks if the ID is matched with a valid User ID. It then checks if the Pseudonym already exists in the system. If not, it associates the requested Pseudonym with the User ID. The user now can be messaged via this Pseudonym in addition to the other Pseudonyms they already own. If the User ID does not exist, or if the Pseudonym already exists, the system sends back appropriate error messages.

In the example given above, the user frank52 requests the additional Pseudonym frankie by sending a message, via SMS or email, to agent@smeak.net, with the words “add,alias,frankie” in the body of the message. The command succeeds. Now, a message to frank52@smeak.net, or to Frankie@smeak.net, will reach the same user. However, the user can choose to provide the Pseudonym “frank52” to some of their contacts and “Frankie” to others, and nobody will be aware that frank52 and frankie are the same user. How this is done is discussed further in the Anonymity and Privacy section below.

### 11. MESSAGING SECURITY

Smeak CMS relies on from addresses to identify senders. In order to avoid spoofing, especially in cases where Credits may be involved, Smeak CMS implements a simple password mechanism. A user can set a short password, either fixed or changing in a specified manner (e.g. different for each day of week) via the web site. Once such a password is set, any message from the User ID must have the password as the first or last characters in the message in order to pass muster as having come from that User ID.

### 12. NON-USERS

The Smeak CMS is not a social network and does not mandate that every user must join it in order to use it. Registered users of Smeak CMS can execute commands, initiate group chats and so on. However there is no mandate that they can only message other registered users. Nor is there a mandate that only registered users can message existing registered users of Smeak.

Smeak CMS implements a novel mechanism of dealing with “Non-Users”. A Non-User is any non-registered user who messages via Smeak to a registered user of Smeak, or is messaged to by a registered user of Smeak.

When Smeak receives a message addressed to what purports to be a Smeak User ID, the system checks to see from the from address whether the sender is a Smeak User. If not, and if the message is not a request to join, or a message to a restricted ID, the system checks if the to address is a valid Smeak user. If yes, then the system creates a “Non-User” structure, which is identical to a registered user structure, except that it is tagged as a “Non-User”. It creates a temporary Pseudonym associated with that structure.

The Smeak User receives the message purportedly from that Pseudonym, thus ensuring that replies to the message will continue to go through the Smeak system and hence continue to maintain privacy of the Smeak registered user.

Thus if an outside party from foo@gmail.com sends a message to frank52@smeak.net, The system creates a “Non-user” structure with an email communication method of foo@gmail.com and a generated Pseudonym such as foo-gmail-55. Frank52 receives the message from foo-gmail-55@smeak.net.

A Smeak Non-User structure can be ‘promoted’ to a user structure when the person who owns the communication method associated with that structure joins Smeak. Similarly, if a (joined) user adds a communication method, which was previously associated with a Non-user structure, the system associates that prior Non-user structure correctly with the newly created User structure.

Thus for example if Mark joins the system by sending a message from foo@gmail.com to the “join” ID or by joining via the web sign-up process, and chooses foo@gmail.com as their communication method, the system takes the existing Non-user structure and associates it with the new user Mark.

### 13. ANONYMITY AND PRIVACY

The Smeak CMS system provides the ability for a user to use a particular pseudonym as their identity in any particular messaging conversation, never revealing any other pseudonym to a participant of that conversation.

This mechanism works as follows. Consider the example of a user, John, who has multiple real identities (i.e., multiple forms of true personally identifying information), and multiple pseudonyms (virtual identities).

John sets a specific virtual identity as the primary identity. Or, in the absence of John doing so, the system select will a specific virtual identity as the primary identity. In the following examples, jdhome has been set as John's primary identity.

John can send messages to anyone using any of the following addressing mechanisms and behaviors. In each of the example lines below, the message may be addressed to the addressee line (<addressee-line>), or to an email ID or phone SMS target that is the Smeak Agent ID with a command line of the form “to,<addressee-line>”.

If the medium of communication is email or email over SMS, the <addressee-line> ends with “@smeak.net” or an equivalent construct denoting Smeak.

Thus, if the communication medium is email, or email over SMS, an example addressee-line would be ‘addressee@smeak.net’ whereas if the communication medium is SMS, the message would be sent as SMS to a mobile phone number representing Smeak with a command line of the form ‘to,addressee’ beginning the message.

With the above understanding, the following addressee lines and their meanings follow:
+User-id: the literal User-id. Even if “User-id” is a nickname that John has created, the ‘+’ will ensure a literal look-up of “User-id”
User-id-nickname: A nickname or contact created by John, that maps to a valid Smeak User-id, email or phone
Group-id-nickname: A nickname or contact created by John, that maps to a valid group
User-id: A unique User-id in Smeak
Group-id: A unique Group-id in Smeak
User-id+Group-id: A Group-id owned by “User-id” where “User-id” translates to a valid User-id in Smeak, and where John is a member of “Group-id”

In all of the above circumstances, the recipient of the message will receive the message as coming from <John's primary alias>. If “jdhome” is the primary alias of John, then on email systems the message will appear to come from jdhome@smeak.net, for example. If John sends a message to user “Tom” thus:
To: tom+jdwork@smeak.net

Tom will receive the message with the From address showing:
From: jdwork+tom@smeak.net

And hence Tom only knows the id jdwork but not the other aliases of John.

Now Tom may very well have tjones as his primary alias. However if Tom replies to this message of John's from any email system, John will never see tjones, but only Tom.

Replies from Tom will come as From: tom+jdwork@smeak.net

In all of the above circumstances, the recipient of the message will receive the message as coming from <John's primary alias>. If “jdhome” is the primary alias of John, then on email systems the message will appear to come from jdhome@smeak.net, for example.

If John wishes to use a different virtual identity as the sender of the message, he further appends “+<virtual-identity>” to the addressee line.

Thus, if John sends a message to User-id+jdwork@smeak.net on an email-based system or to User-id+jdwork on an SMS-based system, the message will appear to come from jdwork@smeak.net, for example.

Thus the system ensures that John's virtual identity is only revealed as desired by John. Further, the system can be programmed using rules such that only certain virtual identities are revealed to certain contacts of John regardless of how John sends messages, thus protecting John's privacy.

The Smeak CMS system stores and executes rules that can be defined by a Smeak user. These rules are executed at multiple levels, either globally at the User account level, or on a per Pseudonym basis, or on the basis of a user's specific communication method.

Example rules are Whitelist and Blacklist rules. Whitelists when enabled, only allow messages from entries within the Whitelist and ignore all others. Blacklists, when enabled instead of Whitelists, reject messages from any entries in the Blacklist. Neither list could be enabled, and that is also a valid status.

Other example rules are specific to communication methods. For instance, messages from certain users can be routed to certain communication methods only, or groups of communication methods. Thus user John could choose to have messages from his wife reach him at both his email methods and his phone via SMS.

Other rules are based on Pseudonyms. A user can define a group, and ensure that messages sent to that group or any member of the group is always sent from a particular Pseudonym. As an example, user John defines a group called “office” and adds contacts into that group, including the contact “Mike”. He then sets up a rule that will send any messages to any member of this group as though it comes from his Pseudonym jdoffice.

John's default Pseudonym is jdhome. When John sends a message addressed to contact “Sam” who is not in the group “office”, as follows: To: sam@smeak.net

The message arrives using thus. From: jdhome@smeak.net

If John wishes to send a message to Sam as from jdoffice, he will need to send it
To: sam+jdoffice@smeak.net

However if John having set up the rule for Mike as above just sends a message to Mike as To: mike@smeak.net

The message to Mike will come From: jdoffice@smeak.net without John having to put in his Pseudonym with a +jdoffice. This eliminates errors of John using the wrong Pseudonym by chance while communicating with Mike.

### 14. USE OF NICKNAMES (CONTACTS) AND LINGO FOR PRIVACY

Messaging privacy is provided uniquely by the Smeak CMS. The intention is that a user's inbox or sent items folder, particularly on mobile devices, do not reveal potentially compromising information, such as the addresses of certain senders or recipients, nor reveal certain words.

A user can set up a “nickname” or “contact” in the Smeak CMS as mentioned earlier. Such a contact can, as with most Smeak CMS features, be created via messaging as well as via the web.

A contact can reference another Smeak User ID or pseudonym, or an email address or phone number or equivalent messaging address. Once created, the user can use this contact to communicate with the user the contact refers to. Uniquely to Smeak, messages coming back from that contact will also not reveal the real ID of the contact.

Thus, as an example, user John creates a contact called “joe” which in reality refers to bambi@gmail.com. John can now send messages to “joe@smeak.net”. These will go to the real address bambi@gmail.com, but in John's email system or phone system, will show as having gone to joe@smeak.net. Any messages that bambi@gmail.com sends to John will also arrive as having come from joe@smeak.net.

Smeak CMS implements this by maintaining a dictionary on a per-user basis that contains the contacts or nicknames, and applying the translation to the appropriate “From:” lines of the incoming messages.

The Smeak CMS also provides the ability, as described earlier in the Lingo section, of creating a private dictionary of codes for words. Once created, the user can use just the codes in their messages. In their sent items, then will show up as the code words, whereas the recipient will see the translation. Similarly, if another user sends a word for which the user has a code, the word will be translated to the code.

Thus, if user John defines the code “water” to mean “beer”, then John can type only “water” in his messages. Recipients will see the translation “beer” instead. If anyone sends a message to John via Smeak CMS that has the word “beer” in it, John's system will only show “water”. An examination by someone of John's inbox and sent-items folders will only show “water”.

The Smeak CMS extends normal messaging systems by modifying the From and To addresses of a message, as well as the content of the message. The To addresses are modified so that if the user responds, the reply goes as from the right Pseudonym, as described above.

The From addresses are modified to use any contact or nicknames defined, such that the message purports to come from the contact or nickname rather than from the real from address.

When the user replies, the records in the sent items folder on the user's system maintain the contact/nickname. However Smeak CMS applies the translation so that the message goes to the right real user.

Smeak CMS privacy is intended to secure the user's device, not the server. Thus user messages sent and received via the device are privacy protected, but the real info is visible on the server in the user's translation dictionary and address book.

Lingo translations are performed by the Smeak CMS modifying the message to insert the Lingo code whenever it sees the definition in an incoming message, and perform the reverse substitution for outgoing messages.

In this manner, the Smeak CMS provides users with privacy against anyone examining their messaging folders such as inbox and sent-items.

### 15. GENERAL COMMAND STRUCTURE

As an extension to the earlier described command structure, the following command structure is presented. A simple “verb, noun, parameter” structure, where:
“verb” is a simple action such as “get”, “set”, “add”, “remove” and “help”.
“noun” is a simple property such as “contact”, “lingo”, etc. As shown later, “noun” can be extended by any user of the system.
“parameters” are sets of values that are different depending on the noun.

The Smeak CMS predefines certain command nouns, such as “lingo”, “contact” etc. as described.

Commands are executed by a user messaging the command to the Smeak CMS. This may be implemented by having a set of restricted Smeak User Id's which only accept commands, such as “Agent” or “Smeak”.

Any user can also create and register their own commands. The “verbs” will still be the same as described above. What the “noun” refers to will be what the user defined. The user will be able to define a URL to invoke that is associated with the “noun”, and the Smeak CMS will invoke the URL with the parameters supplied. In this mechanism, any web site can be made “Smeak compatible” or able to respond to messages.

Thus, consider user John, who has a web site that rates restaurants, the URL being restaurant-rating.com. John registers a command called “rate”, and the URL https://rate.restaurant-rating.com.

Now, John publishes the information to his customers. Now any of his customers who have Smeak accounts can send an email or SMS message to Smeak, of the form: get,john+rate,bobsburgers

The Smeak CMS finds the command noun “rate” owned by user “john”, discovers the URL registered, which is http://rate.restaurant-rating.com, and passes the additional parameter of “bobsburgers” to the URL via a get over http.

This invokes John's web site with the parameters sent in. John codes his site to respond. Smeak CMS will convey this response via the requester's messaging preferences, to the requester.

Thus, a customer Joe, who sends the command “get, john+rate,bobsburgers” to Smeak, will get back the rating that John has coded on his site for the restaurant “bobsburgers”.

By the requester being able to use an appropriate pseudonym, as described above, John may never know the real ID of the requester, hence the requester's privacy is protected. John can nevertheless know the pseudonym of the requester and communicate with the requester that way, however the communication will only reach the requester if the latter has allowed it.

John can also commercialize the capabilities provided by his private commands by charging some number of credits (credits are described earlier) for each invocation.

The system described herein allows anybody with a web site that provides features to “Smeakify” their online services by leveraging Smeak's messaging for utility, better customer interaction, and even monetization, without jeopardizing the privacy of their customers.

Smeak CMS will also provide generic “Smeak Apps” for the popular Smart Phones, such that rather than type the commands in, a UI can select the commands implemented both by the base Smeak CMS system as well as by users. Anybody is also free to build their own Apps that leverage the Smeak command mechanism as described.

What is claimed is:

1. A method of storing and retrieving information via a shared computer system, wherein:
a. A user U creates a first account profile containing one or more data elements describing or pertaining to said user U such as his or her personal data, email addresses, telephone numbers, location, address book, friends/connections, preferences, and groups,
b. said user U creates a second account profile containing one or more data elements describing or pertaining to said user U such as his or her work related email addresses, telephone numbers, address book, coworkers/connections, preferences, and groups,
c. said user U grants to a second party (such as his or her employer) the privilege of managing said second account profile,
d. for each of said first account and said second account, said user U makes or accepts zero or more connection requests to or _{from} the accounts of other system users, such other user accounts thereby becoming pre-defined connections of the respective first account or second account,
e. said user U makes a connection request from said first account to said second account, and accepts said connection request on behalf of said second account profile,
f. said user U encodes a preference that selected pre-defined information contained in said first account profile (such as said user U's current location) may be accessed by then current connections of said second account profile.

2. A method of storing and retrieving information about a user U of a shared computer system as in claim 1, wherein:
a. a user C whose account profile is connected to said second account makes a request for one or more data elements contained in said first account, such as said user U's current location,
b. said shared computer system returns the current value(s) of said one or more data element from said first account to said user C.
